(19) United States
(12) Patent Application Publication
(10) Pub. No.: US 2026/0266292 A1
(43) Pub. Date: Sep. 10, 2026

(54) MAGNETIC LEVITATION DEVICE AND PUMP UNIT

(71) Applicant: Levitronix GmbH, Zurich (CH)

(72) Inventors: Daniel STEINERT, Bulach (CH); Thomas HOLENSTEIN, Umiken (CH)

(21) Appl. No.: 19/545,435

(22) Filed: Feb. 20, 2026

(30) Foreign Application Priority Data
Mar. 5, 2025 (EP) 25161947.4

(51) Int. Cl. F04D 13/02; F04D 29/048; F16C 32/04

(52) U.S. Cl. CPC F04D 13/026; F04D 29/048; F16C 32/0468; F16C 32/0493; F16C 2223/32; F16C 2360/44

(57) ABSTRACT

A magnetic levitation device for the contactless magnetic levitation includes a stator having a cup-shaped recess into which the rotor is inserted. The stator has a back iron, stator poles, each of which has a connecting leg and a pole piece. Each connecting leg extends from a first end to a second end. The first end abuts the back iron. Each pole piece has a contact surface and extends from the contact surface in the radial direction to an end face. The end faces are arranged around the cup-shaped recess. A concentrated winding is arranged on each radial part. Each connecting leg extends from the first end obliquely with respect to the axial direction radially inwards to the second end, such that the back iron surface and a pole piece surface are arranged with an offset with respect to the axial direction.

### CROSS-REFERENCE TO RELATED APPLICATION

This application claims priority to European Application No. 25161947.4, filed Mar. 5, 2025, the contents of which are hereby incorporated herein by reference.

### TECHNICAL FIELD

The disclosure relates to a magnetic levitation device and a pump unit having such a magnetic levitation device.

### BACKGROUND

Magnetic levitation devices for the contactless magnetic levitation of a rotor have the advantage that they manage without mechanical bearings for the rotor. The rotor is levitated or stabilized by magnetic forces which are generated by a stator of the magnetic levitation device. Due to the absence of mechanical bearings, such magnetic levitation devices are suitable in particular for pumping, mixing, centrifuging or stirring devices with which very sensitive substances are conveyed, for example blood pumps, or in which very high demands are placed on the purity, for example in the pharmaceutical industry or in the biotechnological industry, or with which abrasive or aggressive substances are conveyed which would destroy mechanical bearings very quickly, for example pumps or mixers for slurry, sulfuric acid, phosphoric acid or other chemicals in the semiconductor industry.

In the biotechnological industry, such magnetic levitation devices are used for example in connection with bioreactors, for example in the case of centrifugal pumps for conveying the fluids into or out of the bioreactor, or in the case of mixing devices which mix the fluids in the bioreactor. In the semiconductor industry, such magnetic levitation devices are used not only for conveying aggressive or abrasive substances, but also for example for rotation devices with which wafers are rotated.

It is also known to use magnetic levitation devices for viscometers.

An advantageous and configuration known per se of a magnetic levitation device is the configuration in temple construction. Such a magnetic levitation device is illustrated in FIG. 1. The reference signs in FIG. 1 are each provided with an inverted comma in order to make it clear that these components belong to the state of the art.

The characteristic of temple construction is that the stator 2′ of the magnetic levitation device 1′ has a plurality of coil cores 25′, each of which comprises a longitudinal leg 26′, which extends from a first end 261′ in an axial direction A′ to a second end 262′. In this case, the axial direction A′ means that direction which is defined by the desired axis of rotation of the rotor 3′, which is levitated with the magnetic levitation device 1′. The desired axis of rotation is that axis of rotation about which the rotor 3′ rotates in the operating state when it is in a centered and non-tilted position with respect to the stator 2′.

Each coil core 25′ comprises, in addition to the longitudinal leg 26′, a transverse leg 27′, also called pole piece, which is arranged in each case at the second end of the longitudinal leg 262′, and which extends in the radial direction R′-usually inward-, wherein the radial direction R′ is perpendicular to the axial direction A′. The transverse leg 27′ thus extends substantially at right angles to the longitudinal leg 26′. The coil cores 25′ each have the shape of an L, wherein the transverse legs 27′ form the short legs of the L. The rotor 3′ to be levitated is then arranged between the transverse legs 27′.

The plurality of longitudinal legs 26′, which extend in the axial direction A′, and which are reminiscent of the columns of a temple has given this construction its name.

In a configuration, for which an example is shown in FIG. 1, the stator 2′ of the magnetic levitation device 1′ has, for example, six coil cores 25′, which are arranged circularly and equidistantly around a cup-shaped recess, not explicitly illustrated in FIG. 1, into which the rotor 3′ can be inserted. The first ends of the longitudinal legs are usually connected in a circumferential direction by a back iron 28′, which serves to conduct the magnetic flux. The rotor 3′ to be levitated comprises a magnetically active core 31′, for example a permanent magnetic disk or a permanent magnetic ring, which is arranged between the radially inner ends of the transverse legs 27′ and rotates about the axial direction A′ in the operating state, wherein the rotor 3′ is levitated magnetically in a contactless manner with respect to the stator 2′.

For such magnetic levitation devices 1′, it is not necessarily the case that the magnetically active core of the rotor 31′ must be of permanent magnetic design. Such designs are also known, in which the magnetically active core 31′ of the rotor 3′ is designed free of permanent magnets, that is to say without permanent magnets. The magnetically active core of the rotor 31′ is then, for example, of ferromagnetic design and consists, for example, of iron, nickel-iron, cobalt-iron, silicon-iron, Mu-metal or another ferromagnetic material.

Furthermore, designs are possible, in which the magnetically active core of the rotor 31′ comprises both ferromagnetic materials and permanent magnetic materials. For example, permanent magnets can be placed or inserted into a ferromagnetic main body. Such designs are advantageous, for example, if, in the case of large rotors, it is intended to reduce the costs by saving permanent magnetic material.

In order to generate the electromagnetic fields necessary for the contactless magnetic levitation of the rotor 3′, the longitudinal legs 26′ carry windings 61′. The windings 61′ are, for example, designed such that a concentrated winding 61′ is wound around each longitudinal leg 26′, that is to say that the coil axis of each concentrated winding 61′ extends in each case in the axial direction A′. In this case, it is typical for the temple construction that the coil axes of the concentrated windings 61′ run in the axial direction A′ and that the concentrated windings 61′ are not arranged in the radial plane R′, in which the rotor 3′ or the magnetically active core of the rotor 31′ is levitated in the operating state.

Designs are possible in which precisely one concentrated winding 61′ is arranged on each longitudinal leg 26′. In other designs, several concentrated windings 61′, for example precisely two, are provided on each longitudinal leg 26′. Designs are also possible in which windings 61′ are provided which are wound around two longitudinal legs 26′ which are adjacent in the circumferential direction, with the result that these two adjacent longitudinal legs 26′ are both located in the interior of the concentrated winding 61′.

### SUMMARY

The temple construction described above make possible a well-proven magnetic levitation device 1′ which is known from the state of the art, but which still has potential for improvement. In the case of magnetic levitation devices 1′ in temple construction, it has been determined that it is difficult to design them sufficiently compactly. The longitudinal legs 26′ and the concentrated windings 61′ are necessary for the operation of the magnetic levitation device 1′ in temple construction. However, these at the same time also predefine the spatial extent of the device. It is therefore not readily possible to use such a magnetic levitation device 1′ for applications which, for example on account of spatial circumstances, have little space available for the magnetic levitation device 1′.

Conversely, this means that a magnetic levitation device 1′ in temple construction cannot be designed sufficiently compactly for reliable operation in some applications, or only at great expense.

Lack of compactness of the magnetic levitation device 1′ also leads to a large amount of material being required for the production of the individual components. The entire device 1′ therefore has a high weight and higher costs, which in turn can lead to it not being optimally suitable for some fields of use.

Furthermore, it is often challenging to design a magnetic levitation device 1′ in temple construction with more than six coil cores 25′. If the size of the rotor 3′ or of the magnetically active core 31′ cannot be changed, it is therefore difficult to insert, for example, two further coil cores 25′ around the cup-shaped recess 211′. Furthermore, due to the small space available, the longitudinal legs 26′ are arranged very close to one another, which can lead to stray fluxes and therefore high iron losses. A further problem which can lead to high iron losses is that long magnetic paths are produced owing to the construction of the longitudinal legs 26′. However, these are not desirable since the resulting losses must ultimately be dissipated in the form of heat, and therefore the efficiency of the magnetic levitation device in temple construction falls.

Starting from this state of the art, it is therefore an object of the disclosure to propose a magnetic levitation device for the contactless magnetic levitation of a rotor with a disk-shaped or ring-shaped magnetically active core, which magnetic levitation device has a more compact construction and at the same time a higher efficiency.

Furthermore, it is an object of the disclosure to propose a pump unit having such a magnetic levitation device.

The subject matter of the disclosure meeting this object is characterized by the features disclosed herein.

According to the disclosure, a magnetic levitation device is thus proposed for the contactless magnetic levitation of a rotor which has a disk-shaped or ring-shaped magnetically active core, wherein the magnetic levitation device comprises a stator which extends in an axial direction and has a cup-shaped recess which is arranged at a first axial end of the stator and into which the rotor can be inserted. The stator further has a back iron, wherein the back iron has a plurality of radial parts, at least one circumferential part, a back iron bottom surface and a back iron surface, wherein each radial part extends from the circumferential part in a radial direction which is perpendicular to the axial direction, wherein the back iron surface faces the first axial end of the stator and the back iron bottom surface faces a second axial end of the stator. The stator has a plurality of stator poles, each of which has a connecting leg and a pole piece, wherein each connecting leg extends from a first end to a second end, wherein the first end abuts the back iron. Each pole piece has a contact surface which abuts the second end of the connecting leg, wherein each pole piece extends from the contact surface in the radial direction to an end face, wherein all end faces are arranged around the cup-shaped recess. At least one concentrated winding is arranged on each radial part, which winding surrounds the respective radial part. Each connecting leg extends from the first end obliquely with respect to the axial direction radially inwards to the second end, such that the back iron surface and a pole piece surface of the pole piece are arranged with an offset with respect to the axial direction.

The extent of the connecting leg radially inwards means that the second end of the connecting legs is at a smaller distance from the cup-shaped recess than the first end. The oblique extent of the connecting leg with respect to the axial direction means that an axis of the connecting leg encloses an angle with the axial direction which is greater than 0° and less than 90°. The angle is preferably between 20° and 60°. Particularly preferably between 30° and 55°.

The axis of the connecting leg which encloses the angle with the axial direction preferably extends from a first center point of a first contact surface of the connecting leg to a second center point of a second contact surface of the connecting leg, wherein the second contact surface is arranged on the contact surface of the pole piece.

The offset in the axial direction should be greater than 0% and less than 100% of an axial height of the pole piece, wherein the axial height of the pole piece specifies the extent thereof in the axial direction. The offset is preferably between 5% and 75% of the axial height, particularly preferably between 15% and 45%.

The arrangement of the pole piece for the back iron can also be made clear in planes. The back iron surface is located in one radial plane, and the pole piece surface is located in another radial plane which is parallel thereto. The two planes are at a distance from one another in the axial direction which corresponds to the offset. The normal vectors of the two planes are preferably arranged parallel to the axial direction.

In the context of this application, a cup-shaped recess is understood to mean a recess which resembles the shape of a cup. That is to say that the cup-shaped recess has at least one diameter in the radial direction. The outer shape of the cup-shaped configuration can be cylindrical, conical or else can be configured by a mixture of the two shapes. The cup-shaped recess can have both a closed base and an open base or no base at all. It goes without saying that it is possible for the cup-shaped recess to also have smaller artefacts, such as, for example, openings or depressions.

This design of the magnetic levitation device is advantageous since a compact magnetic levitation device is made possible as a result. It is likewise advantageous that it is possible, with substantially the same space requirement, to arrange a significant number of stator poles around the cup-shaped recess than in the case of the temple motor known from the state of the art. This ensures a wider covering, as viewed in the circumferential direction, of that surface of the rotor which faces the end faces of the pole pieces, by the stator poles. A better flux conduction of the magnetic field is thus achieved.

Furthermore, it is advantageous that, as a result of the offset of the pole piece with respect to the back iron, a flat surface of the stator is achieved at the axial upper end of the stator. Without an offset, a flat surface would not be present since the at least one concentrated winding arranged on each radial part of the back iron has an extent in the axial direction, such that a surface of the concentrated winding is arranged above the back iron surface in the axial direction. That is to say that a stator housing which encloses the stator thus has a flat surface at the axial upper end of the stator. In other words, the axially upper surface of the stator housing is located in a radial plane. This is advantageous for the magnetic levitation device since a better interaction between stator and rotor is achieved in this way. The rotor or the magnetically active core has a radial central plane which coincides with a radial central plane of the pole piece. That is to say that the axial position of the rotor when it is inserted into the cup-shaped recess is defined by the axial position of the pole pieces. As a result of the offset between the pole piece and the back iron, the rotor is thus lifted to the maximum extent upward in the axial direction with respect to the axially upper surface of the stator housing, that is to say further away from the second end of the stator in the axial direction. As a result of this maximum lifting of the rotor in the axial direction, the rotor can be designed more compactly, as a result of which the stability of the levitation of the rotor in the stator is improved.

This is advantageous precisely when the magnetic levitation device is intended for the levitation of rotors on which at least one vane is arranged. Such rotors are used, for example, for use as a pump and/or mixer of a fluid. If the rotor has the maximum lifting in such an application, the at least one vane can have a smaller extent in the axial direction, as a result of which forces acting on the vane or rotor further upward in the axial direction are prevented. As a result, tilting moments are reduced and the levitation of the rotor is ensured well and reliably.

It is likewise possible in the case of centrifuges, rotary filters or cross-flow fans that two magnetic levitation devices according to the disclosure or a combination of a magnetic levitation device according to the disclosure with another magnetic levitation device can be used for the joint levitation of a rotor at both rotor ends. In these applications, too, the rotor can advantageously be designed to be short as a result of the magnetic levitation device according to the disclosure, which additionally advantageously increases the flexural resonance frequency of the rotor and displaces it out of the range of the operating frequencies.

If no offset were present between the pole piece and the back iron, the rotor would be arranged axially lower, that is to say closer to the second axial end of the stator in the axial direction, as a result of which forces which influence the operation of the magnetic levitation device in a disturbing manner act on the rotor further above, as viewed in the axial direction, the radial central plane. This would be disadvantageous since greater torques are generated as a result, which ensure that the rotor is tilted. This leads to the stability of the mounting of the rotor in the stator being impaired.

In a preferred embodiment, the back iron comprises several segments, wherein each segment has a radial part and a circumferential part. That is to say, in this embodiment, the number of segments corresponds to the number of radial parts and to the number of circumferential parts. The number of segments is preferably twelve. However, embodiments in which the number is smaller, for example six or eight, or higher, for example 16 or 20, are also possible.

In a preferred embodiment, all segments of the back iron are arranged abutting each other.

In a preferred embodiment, all segments of the back iron are arranged abutting each other without an air gap.

The segments each have a first segment end and a second segment end in the circumferential direction. In a preferred embodiment, the segment has a first shape at the first segment end and a second shape at the second segment end, wherein the first and second shapes are complementary shapes. In other words, the first shape is a male shape, and the second shape is the female counterpart.

This means that both shapes are designed in such a way that the first segment end can be connected to a second segment end of a first adjacent segment in a form-fitting manner and the second segment end can be connected to a first segment end of a second adjacent segment in a form-fitting manner. The first and second shapes are thus designed as two interlocking geometries.

According to a preferred embodiment, the first and second shapes have a circular, semicircular, or oval design. However, other geometric shapes are also possible.

These embodiments have the advantage that a certain degree of flexibility is available when joining the individual segments together, so that they can be moved against each other, for example, if necessary. This also makes it easier to replace individual segments.

According to a preferred embodiment, the first and second shapes have a stepped shape in the axial direction, with the steps at the first and second segment ends being complementary to each other.

In a preferred embodiment, the stator has twelve stator poles, and the rotor has a plurality of rotor poles, preferably eight rotor poles, wherein the rotor poles are configured as four pole pairs.

For the embodiment in which the back iron is not segmented, the twelve stator poles are all arranged on the one back iron. It is understood that the number of twelve stator poles is to be understood purely as an example, there can also be more or fewer than twelve stator poles.

For the embodiment with the segmented back iron, this means that there are preferably also twelve segments of the back iron on which the twelve stator poles are arranged. In other words, it is preferred in this case that a stator pole always forms a unit with a segment, which unit, arranged in the circumferential direction, forms the back iron with stator poles arranged thereon.

However, it is also likewise possible that more than one stator pole is arranged on a segment of the back iron. Thus, for example, in this embodiment, six segments can form the stator which has twelve stator poles, wherein two stator poles are arranged on each segment.

The number of stator poles and of rotor poles can also be smaller or higher than the abovementioned twelve stator poles or eight rotor poles. Likewise, the number of stator poles per segment can be greater or smaller than the abovementioned two stator poles.

In a preferred embodiment, the segment and the pole piece each have an axial thickness in the axial direction, wherein these two axial thicknesses are of equal size and wherein a distance in the axial direction between the back iron bottom surface and the pole piece surface is greater than this axial thickness.

Furthermore, it is preferred that the back iron bottom surface and the pole piece bottom surface are not located in the same radial plane but likewise have an offset with respect to one another and, on the other hand, that the pole piece surface is arranged closer to the axially upper end of the stator in the axial direction than the back iron surface.

In a preferred embodiment, the back iron bottom surface and the back iron surface are each arranged in a plane that is arranged perpendicular to the axial direction.

In a preferred embodiment, the segments form a continuous and/or composite ring that forms the back iron and is arranged perpendicular to the axial direction A.

According to a preferred embodiment, the at least one concentrated winding is of conical configuration. In this case, all types of winding known to the person skilled in the art from the state of the art are possible for conical windings, and also, for example, a stepped conical winding. Likewise, all winding techniques known from the state of the art are meant in which a high degree of compactness and a high filling factor are achieved by the layer construction with good producibility at the same time. These include, for example, orthocyclic winding, wire cross-sectional design such as, for example, round wire, flat wire or rectangular wire, placement of the winding starts and ends. Accordingly, winding strands can also be routed in series or in parallel and optionally twisted.

Corresponding insulation measures such as coil holders and insulation layers are also self-evident.

Furthermore, it is preferred that the at least one concentrated winding has a radially first end and a radially second end, wherein the radially first end faces the circumferential part and the radially second end faces the cup-shaped recess, wherein the at least one concentrated winding has a first outer diameter at the radially first end and a second outer diameter at the radially second end, wherein the first outer diameter is greater than the second outer diameter.

This embodiment of the at least one concentrated winding is advantageous for the compactness of the magnetic levitation device. It is thereby possible to be able to arrange the stator poles more flexibly.

Particularly preferably, several, and specifically all, concentrated windings are designed in such a way that the respective concentrated winding has the first outer diameter at the radially first end and the second outer diameter at the radially second end, wherein the first outer diameter is in each case greater than the second outer diameter.

In a preferred embodiment, the end face of the pole piece is configured as a curved surface. It is particularly preferred here that the rounding of the end face is configured coaxially with respect to the cup-shaped recess. In other words, the end face of the pole piece is a segment of a cylinder surface, wherein the central axis of this cylinder coincides with the central axis of the cup-shaped recess, and the radius of this cylinder is greater than that of the cup-shaped recess, such that the end face does not project into the cup-shaped recess.

In a preferred embodiment, the end face is configured wider with respect to the circumferential direction than the maximum extent of the contact surface in the circumferential direction. This means that one of the two edges of the end face which extend in the circumferential direction is longer than one of the edges of the contact surface which extend in the circumferential direction. If the end face is configured as a curved surface, the length of one of the circular arcs of the segment of the cylinder surface in the radial plane is greater than the length of one of the edges of the contact surface which extend in the circumferential direction.

This widening of the end face in the circumferential direction has the advantage since the magnetic functionality is thereby promoted. For example, the passive stiffness and the active levitation forces can be improved.

According to a further preferred embodiment, the end face is configured narrower with respect to the circumferential direction than the maximum extent of the contact surface in the circumferential direction. This means that one of the two edges of the end face which extend in the circumferential direction is shorter than one of the edges of the contact surface which extend in the circumferential direction.

According to a preferred embodiment, the segments are produced in a laminated manner from back iron elements, wherein the back iron elements are stacked in the axial direction.

According to a further preferred embodiment, the connecting leg is produced in a laminated manner from elements, wherein the elements are stacked in the circumferential direction of the stator.

According to a likewise preferred embodiment, the pole piece is produced in a laminated manner from pole elements, wherein the pole elements are stacked in the axial direction.

One advantage of the laminated design is that it ensures a reduction of the eddy current losses in the respective component (segment, connecting leg, pole piece).

Most eddy current losses occur at the pole pieces since the distance between adjacent pole pieces, in particular at the ends thereof which face the cup-shaped recess, is particularly small. This applies in particular to the embodiments in which the end face is configured wider with respect to the circumferential direction than the maximum extent of the contact surface in the circumferential direction. The reason for this is that the eddy current losses result primarily from orthogonal fields, that is to say fields which penetrate the pole elements orthogonally. Precisely in the case of small distances between the pole pieces, such orthogonal fields have the possibility of flowing in the circumferential direction from the pole piece of a first stator pole to the pole piece of a second, adjacent stator pole. Eddy currents through orthogonal fields in the circumferential direction are prevented by the pole elements of the pole piece which are stacked in the axial direction. This leads to the eddy current losses being drastically reduced.

A further important advantage results as a result. The end faces of the pole pieces can be arranged significantly closer to one another in the circumferential direction since fields which flow in the circumferential direction from the pole piece of a first stator pole to the pole piece of a second, adjacent stator pole flow parallel to the pole elements which are stacked in the axial direction and therefore do not generate eddy current losses. For example, the passive stiffness and the active levitation forces can thus be improved and/or a more compact construction of the stator is possible.

In preferred embodiments, the pole piece is produced from a soft magnetic material. In this case, it is preferred that the pole pieces and/or the segments and/or the connecting leg are produced from electrical sheet metal. According to the general definition, an electrical sheet metal is understood to mean a soft magnetic material for magnetic cores. Soft magnetic materials are usually referred to as materials which have a low coercive field strength. The coercive field strength is that magnetic field strength which is required in order to demagnetize a substance. In the context of this application, a soft magnetic material is understood to mean a material which has a coercive field strength, more precisely a coercive field strength of the magnetic polarization, which is less than 2′000 A/m. Further suitable soft magnetic materials for the stator poles and the back iron are, for example, ferromagnetic or ferrimagnetic materials, that is to say in particular iron, nickel-iron, cobalt-iron, silicon-iron or Mu-metal.

The change in orientation of the laminated design between the individual components (segment, connecting leg, pole piece) once again ensures a further reduction of the eddy current losses of the entire magnetic levitation device.

In preferred embodiments, the back iron elements are laminated axially (that is to say stacked in the axial direction), the connecting leg which is arranged thereon then has elements which are stacked in the circumferential direction, and the pole piece which is arranged thereon in turn has axially stacked pole elements. This arrangement and the change in orientation ensures that the losses in the magnetic levitation device are reduced.

The elements of the connecting legs which are stacked in the circumferential direction have the advantage that lower losses occur here and the magnetic resistance is reduced compared with a stacking of the elements of the connecting legs in the axial direction. The reason for this is that, in the case of the elements which are stacked in the circumferential direction, the magnetic field does not have to pass through the lamination planes in the axial direction. That is to say, conversely, if the connecting leg were laminated in the axial direction, the magnetic field would have to flow in the axial direction through the boundaries between adjacent lamination planes and would both generate losses and experience an increased magnetic resistance.

As a result of the offset between the segment and the pole piece and the associated lifting of the rotor in the axial direction, an arrangement of the elements of the connecting legs which is stacked in the circumferential direction is advantageous since said elements can conduct the magnetic fields both in the radial direction and in the axial direction.

Furthermore, it is possible that the pole piece and/or the connecting leg are produced from a powder composite material, in particular a soft magnetic powder composite material. In this case, these materials, which are referred to as “soft magnetic composite (SMC)”, can be high-purity iron powder with a specific surface coating. The specific surface coating is electrically insulating in this case. SMCs are known primarily for their application in the conduction of high-frequency magnetic fields (frequency>>1 kHz). However, an application at lower frequencies has not been known hitherto. A lower frequency means frequencies which are less than 65 Hz.

Further advantages of the soft magnetic powder composite materials are that they have a very good capability for three-dimensional flux conduction and have a high electrical resistance and a high permeability and thus have virtually no eddy current losses. Precisely the capability for three-dimensional flux conduction, without high eddy current losses being generated in the process, ensures that preferably soft magnetic powder composite materials are used for the pole piece and/or the connecting leg.

Since soft magnetic powder composite materials have comparatively high hysteresis losses, in some embodiments soft magnetic powder composite material is used for producing the pole pieces and/or connecting legs. As a result, a balanced means is found between the reduction of the eddy current losses at the points at which they are particularly large and the undesired influence of the powder composite material on the magnetic circuit.

The attachment of a pole piece to a connecting leg and the attachment of the connecting leg to the radial part of a segment can be effected by a plurality of possible types of joining. These include, inter alia, a force-fitting type of joining, such as, for example, clamping or crimping, a form-fitting type of joining, such as, for example, screwing or plugging, or a cohesive connection, such as, for example, adhesive bonding or welding. It is likewise possible to produce the connections via tongue-and-groove connections and/or bung connections, such as, for example, pins, prongs or dovetail connections. In a preferred embodiment, the cohesive type of joining is implemented by adhesive bonding. This has the advantage over clamping or screwing that no excessive stresses occur in the material. Furthermore, the force-fitting and form-fitting types of joining have the advantage that they have a low susceptibility to defects which occur, for example, as a result of ageing or faults during adhesive bonding.

According to a preferred embodiment, the end face has a shape transition, preferably a rounding off or a step, at an edge which constitutes the transition to the pole piece surface. In other words, the edge which is located at the axially upper end of the end face of the pole piece and likewise constitutes the radially inner edge of the pole piece surface has a shape transition. On the one hand, a shape transition can be understood to mean that the transition from the end face to the pole piece surface has a radius at the edge. It can also be said that the edge is broken. If the pole piece is designed in a laminated manner from pole elements which are stacked in the axial direction, the pole piece can likewise have a shape transition. In this case, in addition to the shape transitions just mentioned, a shape transition can also be understood to mean that at least one of the pole elements which are located at the axially upper end of the pole piece has a smaller extent in the radial direction than the other elements. In other words, this at least one pole element is set back with respect to the other pole elements, as viewed in the radial direction from the rotor, that is to say that it is at a greater distance from the rotor than the other pole elements.

According to a preferred embodiment, the end face has at least one slot which extends in the axial direction. That is to say, in other words, that the at least one slot can extend in the axial direction in any length in the end face.

Furthermore, it is preferred that several slots are arranged parallel or approximately parallel to one another in the end face.

The arrangement of the several slots parallel to one another is advantageous since they are thereby also arranged parallel or at least approximately parallel to the course of the magnetic field, with the result that they do not block the latter.

Furthermore, it is preferred that the at least one slot extends from the pole piece surface to the pole piece bottom surface. This extent would thus be the maximum possible extent of a slot in the end face in the axial direction.

For a possible design in which the end face has more than one slot, it is possible that one slot extends from the pole piece bottom surface in the axial direction and a second slot extends from the pole piece surface in the axial direction opposite the first slot. In this case, it is possible that the two slots each have an extent in the axial direction which is less than 50% of the extent of the end face in the axial direction. That is to say that, in other words, the end face has two slots which do not touch one another in the center of the end face and at least one pole element of the pole piece is thus located there, which pole element is not captured by the slot.

The introduction of at least one slot into the end face of the pole piece constitutes an electrical insulation. That is to say that the at least one slot ensures that the path of the eddy currents in the pole elements is interrupted and thus blocked. Eddy currents which result from magnetic fields emerging from the pole elements in the axial direction can thus be prevented or reduced. This has the consequence that only small eddy currents remain in the pole piece and the eddy current losses in the pole piece as a whole are drastically reduced.

The production of the slots can be effected by various methods. These include, inter alia, mechanical methods, such as, for example, milling, punching or cutting, the latter also including the use of lasers and/or water jet cutters and/or wire erosion.

According to a preferred embodiment, the connecting leg and the pole piece are configured in one piece as a tooth. The attachment of the tooth to the back iron or to the segment can likewise be effected by the possibilities just described.

According to a preferred embodiment, the tooth can be produced from a solid material. The SMC already described is suitable for this.

According to a preferred embodiment, the tooth is produced in a laminated manner from tooth elements, wherein the tooth elements are stacked in the circumferential direction of the stator. Here, it is particularly advantageous that the stacking of the tooth elements is effected in the circumferential direction so that the magnetic field can be conducted both in the radial direction and in the axial direction and, at the same time, the effect for reducing the eddy current losses in the case of fields in the axial and radial direction is maintained.

It is preferred that the tooth is produced from a soft magnetic material.

According to a particularly preferred embodiment, the stator of the magnetic levitation device is configured for generating a torque with which the rotor can be driven magnetically in a contactless manner for rotation about the axial direction.

Here, the stator is configured as a bearing and drive stator, which is both the stator of the electrical drive and the stator of the magnetic levitation. With the electrical windings of the stator, a magnetic rotary field can be generated which, on the one hand, exerts a torque on the rotor which brings about the rotation thereof about a desired axis of rotation and which, on the other hand, exerts an arbitrarily adjustable transverse force on the rotor so that the radial position thereof can be actively controlled or regulated.

Precisely with regard to the embodiment in which the magnetic levitation device is configured for generating a torque, the design with the wider end face is advantageous since the magnetic functionality is thereby promoted. For example, an increased torque can be generated or the passive stiffness or the active bearing forces can be improved.

According to a preferred embodiment, the magnetic levitation device is configured as an electromagnetic rotary drive or as a mixing device or as a centrifuge or as a cross-flow fan or as a rotary filter or as a viscometer.

That is to say that the magnetic levitation device according to the disclosure can be configured or used for various fluid conveying units, such as those just mentioned. In this case, the fluid conveying unit comprises the rotor, wherein the rotor supplies energy to a fluid by rotation and thus sets it in motion.

Furthermore, an electromagnetic rotary drive, which is also referred to as a stepped motor, is proposed by the disclosure, wherein the electromagnetic rotary drive comprises a magnetic levitation device according to the disclosure, and a rotor with a disk-shaped or ring-shaped magnetically active core, wherein the rotor can be inserted into the cup-shaped recess, and wherein the rotor is configured as a rotor of the electromagnetic rotary drive.

Such electromagnetic rotary drives are also known by the term “bearingless motor”. The term “bearingless motor” in this case means an electromagnetic rotary drive in which the rotor is levitated completely magnetically with respect to the stator, wherein no separate magnetic bearings are provided.

Furthermore, a pump unit for a magnetic levitation device according to the disclosure is proposed by the disclosure, wherein the pump unit comprises the rotor and the pump unit has a pump housing with an inlet and with an outlet—20—for a fluid to be conveyed. The rotor is arranged in the pump housing, wherein the rotor has a plurality of vanes for conveying the fluid. The pump housing delimits a pump chamber, wherein the pump housing has a cover part and a base part. The base part has a cylindrical or conical cup for receiving the rotor, which cup can be inserted into the cup-shaped recess of the stator.

Further advantageous measures and embodiments of the disclosure emerge from the present disclosure.

### BRIEF DESCRIPTION OF THE DRAWINGS

In the following, the disclosure is explained in more detail on the basis of exemplary embodiments and on the basis of the drawing. The drawings show:

FIG. 1 is a perspective representation of a magnetic levitation device known from the state of the art according to the temple construction,

FIG. 2 is a perspective representation of a first exemplary embodiment of a magnetic levitation device according to the disclosure,

FIG. 3 is a schematic sectional representation for an embodiment of a magnetic levitation device according to the disclosure with stator housing,

FIG. 4 is a perspective representation of a segment with stator pole arranged thereon of the exemplary embodiment from FIG. 2;

FIG. 5 is a perspective representation of the segment with stator pole arranged thereon from FIG. 4 with a first winding form,

FIG. 6 is a plan view of the segment with stator pole arranged thereon with the first winding form from FIG. 5,

FIG. 7 is a plan view of a segment with stator pole arranged thereon with a second winding form,

FIG. 8 is a perspective representation of a second embodiment of a segment with stator pole arranged thereon,

FIG. 9 is a perspective representation of a third embodiment of a segment with stator pole arranged thereon,

FIG. 10 is a perspective representation of a fourth embodiment of a segment with stator pole arranged thereon and a first winding form,

FIG. 11 is a perspective representation of a fifth embodiment of a segment with stator pole arranged thereon and a first winding form,

FIG. 12 is a perspective representation of a sixth embodiment of a segment with stator pole arranged thereon and a first winding form,

FIG. 13 is a schematic sectional representation of a second exemplary embodiment of a magnetic levitation device according to the disclosure,

FIG. 14 is a plan view on a third exemplary embodiment of a magnetic levitation device according to the disclosure,

FIG. 15 is a plan view on a fourth exemplary embodiment of a magnetic levitation device according to the disclosure,

FIGS. 16A and 16B are a schematic representations of the wiring of a magnetic levitation device according to the disclosure,

FIG. 17 is a sectional representation of a magnetic levitation device according to the disclosure with a pump unit inserted therein, and

FIG. 18 is a perspective sectional representation of a magnetic levitation device according to the disclosure with a mixing unit inserted therein.

### DETAILED DESCRIPTION

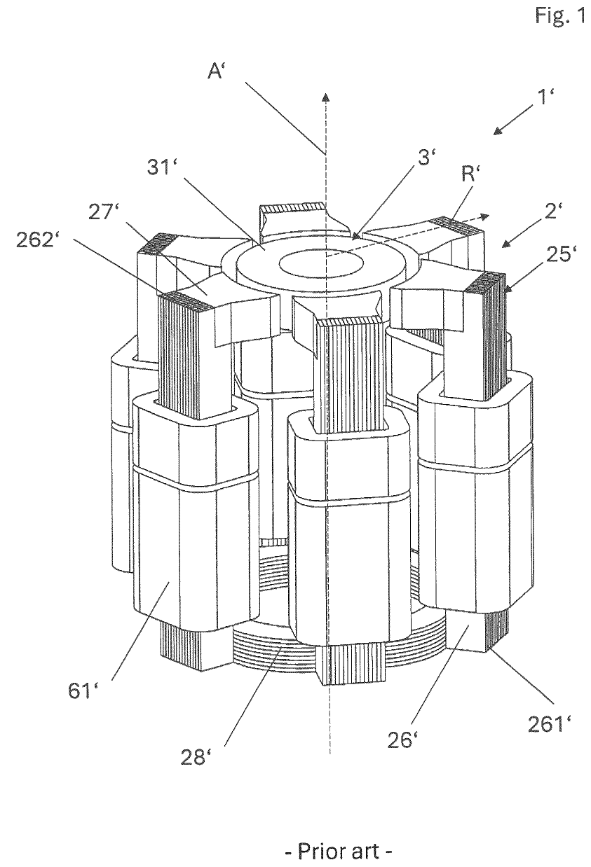

As already explained above, FIG. 1 shows a perspective representation of a magnetic levitation device 1′ known from the state of the art according to the temple construction.

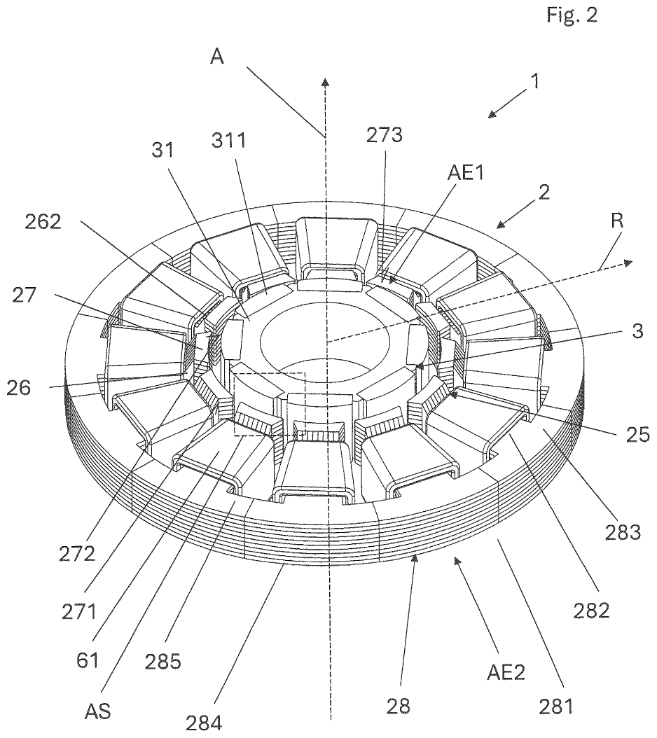

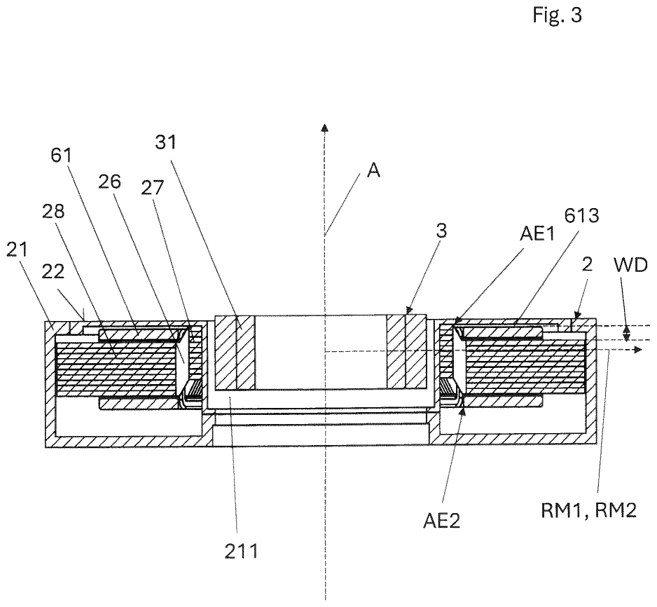

FIG. 2 shows a perspective representation of an exemplary embodiment of a magnetic levitation device according to the disclosure, which is denoted as a whole by the reference sign 1. The magnetic levitation device 1 is designed for the contactless magnetic levitation of a rotor 3 which comprises a disk-shaped or ring-shaped magnetically active core 31. The magnetic levitation device 1 comprises a stator 2. The stator 2 usually comprises a stator housing 21 (FIG. 3) which, however, is not illustrated in FIG. 2 for reasons of better clarity. Therefore, FIG. 3 illustrates in a schematic sectional representation an embodiment of a stator housing 21. FIG. 3 is only intended to serve for the illustration in order to show how an encapsulation of the interior of the stator 2 which is necessary for the operation of the magnetic levitation device 1 looks. For this reason, the other components of the stator 2 are only illustrated schematically and are to be understood purely for illustrative purposes.

During the operation of the magnetic levitation device 1 in regions in which, for example, chemically aggressive substances are used, it is important that the interior of the stator 2 is securely encapsulated and is thus protected from these substances. In order that a rotor 3 can nevertheless be used, the stator housing 21 has at one axial end a cup-shaped recess 211 into which the rotor 3 can be inserted.

The part of the stator housing 21 which is located close to the concentrated windings 61 at the upper axial end AE1 of the stator 2 and the part of the stator housing 21 which faces the cup-shaped recess 211 are preferably manufactured from a low-loss material, particularly preferably from a material which is not electrically conductive or is only slightly electrically conductive, such as, for example, plastics. The other parts of the stator housing 21 are preferably manufactured from a material which is highly thermally conductive, such as, for example, aluminum. The stator housing 21 is preferably hermetically sealed or, depending on the design of the housing 21, is already hermetically designed during production so that no substances harmful to the interior of the magnetic levitation device 1 can come into contact with the stator 2. Exemplary embodiments are also possible in which the housing 21 has coatings, e.g., one or more polymer coatings, which are chemically

A cooling device can also be provided in the stator housing 21, which cools the magnetic levitation device 1, in particular the stator 2, and thus protects it from overheating.

The stator housing 21 can be filled with a casting compound which, on the one hand, fixes the stator 2 in a predetermined position and, on the other hand, contributes to the thermal regulation of the stator 2 or the magnetic levitation device 1.

The electronics for operating the magnetic levitation device 1 can either be arranged internally, i.e., inside the stator housing 21, or completely or partially externally, e.g., in a separate electronic component. The electronic component can, for example, be arranged away from the magnetic levitation device 1 and connected via one or more cables, or it can be attached to the outer wall of the housing 21, for example. Inter alia, the electronics contain not only all components for the levitation and drive of the rotor, but also, for example, for the sensor technology.

The rotor 3 is configured for rotation about a desired axis of rotation. This desired axis of rotation defines an axial direction A. The central axis of the stator 2 which extends in the axial direction A usually coincides with the desired axis of rotation. The desired axis of rotation in this case denotes that axis about which the rotor 3 rotates in the operating state when the rotor 3 is in a centered and non-tilted position with respect to the stator 2, as is illustrated in FIG. 2.

The stator further has a back iron 28, wherein the back iron 28 comprises several segments 281—here twelve segments 281—of which each segment 281 has a radial part 282, a circumferential part 283, a back iron bottom surface 284 and a back iron surface 285. However, exemplary embodiments in which the back iron 28 has no segments 281 are likewise also possible.

The number of segments 281 in this exemplary embodiment is purely exemplary. The back iron 28 can also comprise more or less than twelve segments 281. Each radial part 282 extends from the circumferential part 283 in a radial direction R which is perpendicular to the axial direction A.

At least one concentrated winding 61 which surrounds the respective radial part 282 is arranged on each radial part 282. The at least one concentrated winding 61 has a radially first end 611 and a radially second end 612, wherein the radially first end 611 faces the circumferential part 283 and the radially second end 612 faces the cup-shaped recess 211. In other embodiments, more than one concentrated winding 61 can also be arranged on the radial part 282. For example, there are exemplary embodiments in which precisely two concentrated windings are in each case provided on each radial part 282, each of which windings surrounds the respective radial part 282, wherein the two windings 61 which are arranged on the same radial part 282 are arranged adjacent to one another with respect to the axial direction R.

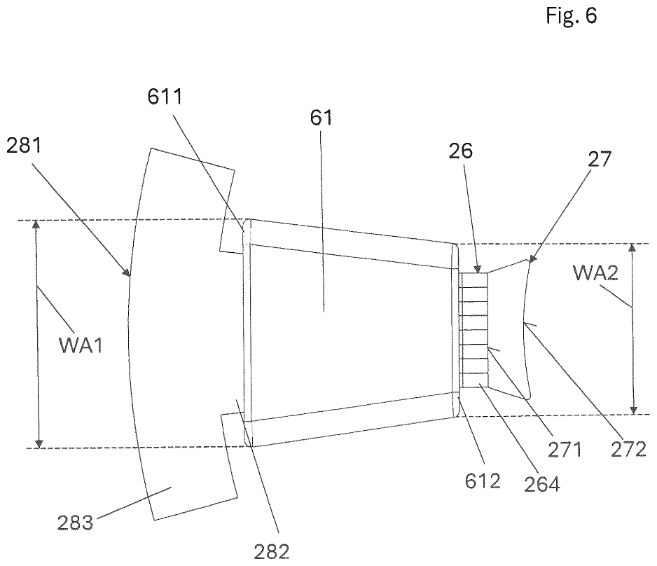

In this exemplary embodiment, the concentrated windings 61 are of conical configuration. For better understanding, a plan view of a segment 281 with stator pole 25 arranged thereon with a first winding form is shown in FIG. 6. In other words, a concentrated winding 61 of conical configuration is understood to mean a winding 61, wherein the at least one concentrated winding 61 has a first outer diameter WA1 at the radially first end 611 and a second outer diameter WA2 at the radially second end 612, wherein the first outer diameter WA1 is greater than the second outer diameter WA2.

The concentrated windings 61 serve to generate electromagnetic fields with which the rotor 3 can be magnetically levitated in the cup-shaped recess 211 (FIG. 3) in a contactless manner.

The back iron surface 285 faces the first axial end AE1 of the stator 2 and the back iron bottom surface 284 faces a second axial end AE2 of the stator 2.

The stator 2 has a plurality of stator poles 25—here twelve stator poles 25—each of which has a connecting leg 26 and a pole piece 27. The number of stator poles 25 is to be understood purely by way of example; more or fewer stator poles 25 can also be present. The number of stator poles 25 in this exemplary embodiment is equal to the number of segments 281, since one stator pole 25 is arranged on each segment 281. However, exemplary embodiments are also possible in which more than one stator pole 25 is arranged on a segment 281. With the number of stator poles 25 which are mentioned in this exemplary embodiment, it would therefore also be possible for in each case two stator poles 25 to be arranged on a segment 281, such that only six segments 281 would be present.

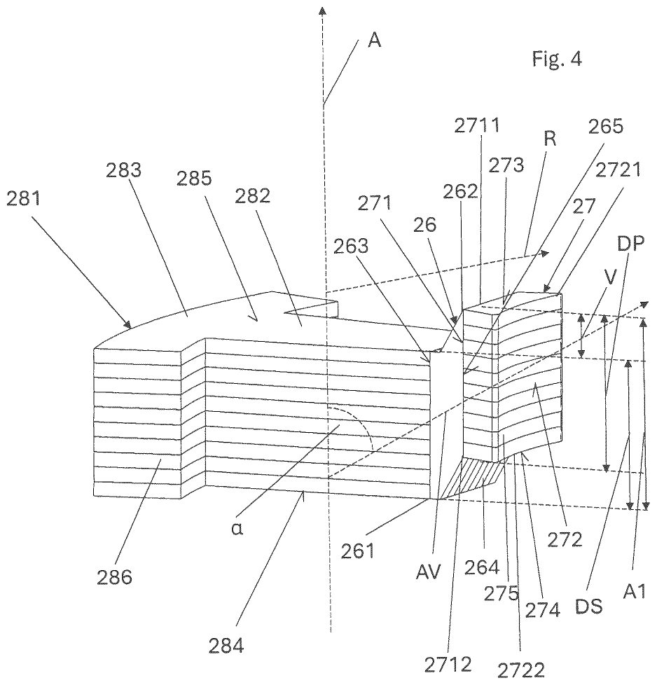

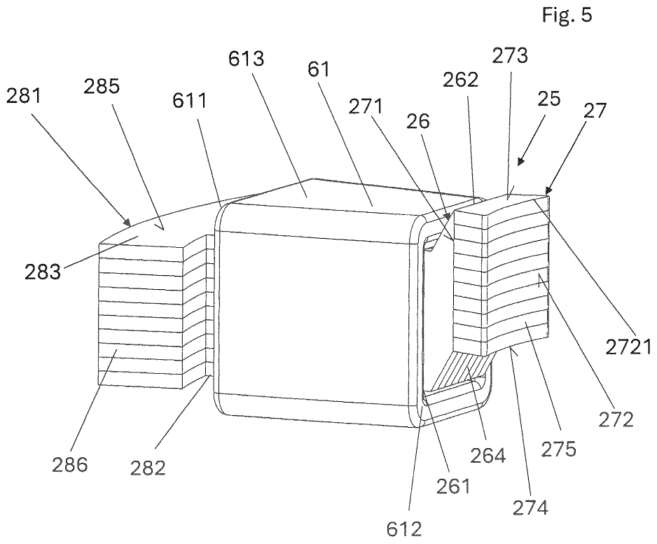

For better understanding, a perspective representation of a segment 281 with stator pole 25 arranged thereon is illustrated in FIG. 4 and, in addition, with a concentrated winding 61 of the magnetic levitation device 1 from FIG. 2 surrounding the radial part 282 in FIG. 5.

Each connecting leg 26 extends from a first end 261 to a second end 262, wherein the first end 261 abuts the back iron 28 or the in each case one segment 281. The connecting leg 26 has a first contact surface 263 which corresponds to that surface which is in contact with the segment 281. Furthermore, each pole piece 27 has a contact surface 271 which abuts the second end 262 of the connecting leg 26. The pole piece 27 extends from this contact surface 271 in the radial direction R to an end face 272. The end faces 272 of all pole pieces 27 are arranged around the cup-shaped recess 211.

There are intermediate spaces between adjacent pole pieces 27, wherein at least one sensor is introduced in at least one intermediate space. However, several intermediate spaces can also have at least one sensor, such that, in some exemplary embodiments, at least one sensor is arranged in each intermediate space. The at least one sensor can be provided, for example, for measuring the rotor properties, such as, for example, the position of the rotor, and/or for measuring stator properties, such as, for example, the temperature. The following types of sensors can be used for this, inter alia: Hall sensors, eddy current sensors, optical sensors, capacitive sensors, temperature sensors. Likewise, combinations of the abovementioned sensors can be provided. In all the exemplary embodiments shown, no sensors are illustrated for better clarity.

In the exemplary embodiment in FIG. 2, the end faces 272 of the pole pieces 27 are each configured as a curved surface. The rounding of the end faces 272 is configured coaxially with respect to the cup-shaped recess 211. In other words, the end faces 272 of the pole pieces 27 are a segment of a cylinder surface, wherein the central axis of this cylinder coincides with the central axis of the cup-shaped recess 211 and the radius thereof is greater than that of the cup-shaped recess 211, such that the end faces 272 do not project into the cup-shaped recess 211. However, exemplary embodiments in which the end faces 272 have no rounding are also possible.

Furthermore, the end faces 272 in FIG. 2 are configured wider with respect to the circumferential direction than the maximum extent of the contact surface 271 in the circumferential direction. This means that one of the two edges 2721, 2722 of the end face 272 which extend in the circumferential direction is longer than one of the edges 2711, 2712 of the contact surface 271 which extend in the circumferential direction. If the end face 272 is configured as a curved surface, the length of one of the circular arcs of the segment of the cylinder surface in the radial plane is greater than the length of one of the edges 2711, 2712 of the contact surface 271 which extend in the circumferential direction.

This widening of the end face 272 in the circumferential direction has the advantage since the magnetic functionality is thereby promoted. For example, the passive stiffness and the active levitation forces can be improved.

However, exemplary embodiments in which the end faces 272 are of equal width or narrower than the maximum extent of the contact surface 271 in the circumferential direction are also possible.

The segments 281 of the back iron are arranged adjacent to one another on a circular line, such that the pole pieces 27 connected to the segments 281 via the connecting legs 26 or the end faces 272 thereof surround the magnetically active core 31 of the rotor 3 when the rotor 3 is inserted into the cup-shaped recess 211.

Each connecting leg 26 extends from the first end 261 obliquely with respect to the axial direction A radially inwards to the second end 262, such that the back iron surface 285 and a pole piece surface 273 of the pole piece 27 are arranged with an offset V with respect to the axial direction A.

The extent of the connecting leg 26 radially inwards means that the second end 262 of the connecting legs is at a smaller distance from the cup-shaped recess 211 than the first end 261. The oblique extent of the connecting leg 26 with respect to the axial direction A means that an axis AV of the connecting leg 26 encloses an angle α with the axial direction A which is greater than 0° and less than 90°. The angle α is preferably between 20° and 60°, particularly preferably the angle α is between 30° and 55°. The axis AV of the connecting leg 26 which encloses the angle α with the axial direction A preferably extends from a first center point of the first contact surface 263 of the connecting leg 26 to a second center point of a second contact surface 265 (FIG. 4) of the connecting leg 26, wherein the second contact surface 265 is arranged on the contact surface 271 of the pole piece 27.

If the state of the art from FIG. 1 is now compared with the exemplary embodiment of the magnetic levitation device 1 in FIG. 2, it can be seen directly that the magnetic levitation device 1 is of significantly more compact design—in particular with respect to the axial direction A. A further advantage is that significantly more stator poles 25 can be arranged around the cup-shaped recess 211 in the magnetic levitation device 1 according to the disclosure. This ensures a wider covering, as viewed in the circumferential direction, of that surface of the rotor 3 which faces the end faces 272 of the pole pieces 27, by the stator poles 25. A better flux conduction of the magnetic field is thus achieved.

Furthermore, it is advantageous that, as a result of the offset V of the pole piece 27 with respect to the segment 281, a flat surface of the stator 2 is achieved at the axial upper end of the stator AE1. Without an offset V, a flat surface would not be present since the at least one concentrated winding 61 arranged on each radial part 282 of the segments 281 has an extent WD (FIG. 3) in the axial direction A, such that a surface 613 of the concentrated winding 61 is arranged above the back iron surface 285 in the axial direction. That is to say that a stator housing 21 which encloses the stator 2 thus has a flat surface at the axial upper end AE1 of the stator 2. In other words, the axially upper surface 22 of the stator housing 21 is located in a radial plane. This is advantageous for the magnetic levitation device 1 since a better interaction between stator 2 and rotor 3 is achieved as a result. If the magnetic levitation device 1 is configured for an application such as, for example, as a mixing device, the offset V further has the advantage that the rotor 3 can be arranged closer to the intended point of the mixing device. As a result, the magnetic levitation device 1 can be designed more compactly.

Furthermore, it is advantageous that the concentrated windings 61 can be arranged closer to the rotor 3, as a result of which the losses in the magnetic levitation device 1 are reduced.

The rotor 3 or the magnetically active core 31 has a radial central plane RM1 (FIG. 3) which, in the rest position, coincides with a radial central plane RM2 of the pole piece 27. This ensures that the levitation of the rotor 3 is ensured well and reliably.

The segment 281 and the pole piece 27 each have an axial thickness DS, DP (FIG. 4) in the axial direction A, which are of equal size in this exemplary embodiment and wherein a distance A1 in the axial direction A between the back iron bottom surface 284 and the pole piece surface 273 is greater than the axial thickness DS or DP. However, other embodiments are also possible, wherein the axial thicknesses DS, DP are not of equal size, i.e. are either greater or less, and the distance relationship is thus superfluous.

The offset V in the axial direction A should be greater than 0% and less than 100% of the axial thickness DP of the pole piece 27. The offset V is preferably between 5% and 75% of the axial thickness DP, particularly preferably between 15% and 45%.

This means that the pole piece 27 is displaced upward in the axial direction A in the direction of the axially upper end AE1 with respect to the segment 281.

This likewise has the consequence that, on the one hand, the back iron bottom surface 284 and the pole piece bottom surface 274 are not located in the same radial plane but likewise have the offset V with respect to one another and, on the other hand, that the pole piece surface 273 is arranged closer to the axially upper end AE1 of the stator 2 in the axial direction A than the back iron surface 285.

Preferably, the pole piece surface 273 is arranged closer to the axially upper end AE1 of the stator 2 in the axial direction A than a surface of the winding 61, wherein the surface of the winding 61 is that surface which is arranged closest to the axially upper end AE1. This also applies in the case where the winding 61 is enclosed by insulation or the like.

In this exemplary embodiment of the magnetic levitation device 1, the components (segment 281, connecting leg 26 and pole piece 27) are all designed in a laminated manner from elements (264, 275, 286).

Here, the segments 281 are produced in a laminated manner from back iron elements 286, wherein the back iron elements 286 are stacked in the axial direction A. The connecting legs 26 are produced in a laminated manner from elements 264, wherein the elements 264 are stacked in the circumferential direction of the stator 2. The pole pieces 27 are produced in a laminated manner from pole elements 275, wherein the pole elements 275 are stacked in the axial direction A.

The number of elements (264, 275, 286) is to be understood purely by way of example in all exemplary embodiments and figures. The number can be greater than or else smaller than illustrated.

The change in orientation of the laminated design between the individual components (281, 26, 27) ensures a reduction of the eddy current losses of the entire magnetic levitation device.

The elements 264 of the connecting leg 26 which are stacked in the circumferential direction have the advantage that lower losses occur here and the magnetic resistance is reduced than a stacking of the elements 264 of the connecting leg 26 in the axial direction A. The reason for this is that, in the case of the elements 264 which are stacked in the circumferential direction, the magnetic field does not have to pass through the lamination planes and in each case insulation between the lamination planes, in the axial direction A. That is to say, conversely, if the connecting leg 26 were laminated in the axial direction A, the magnetic field would have to pass through the lamination planes and would both generate losses and experience an increased magnetic resistance.

The orientations of the stacking of the respective elements (264, 275, 286) are based on this exemplary embodiment. A different orientation of the stacking of their respective elements (264, 275, 286) is also possible for all components (281, 26, 27). However, there is preferably a change in orientation at the transition from one component (281, 26, 27) to the component (281, 26, 27) which is arranged thereon.

One advantage of the laminated design is that it ensures a reduction of the eddy current losses in the respective component (281, 26, 27).

Most eddy current losses occur at the pole pieces 27 since the distance between adjacent pole pieces 27, in particular at the ends thereof which face the cup-shaped recess 211, is particularly small. The fields initially emerge at the pole piece 27 in the radial direction A. Eddy currents are effectively reduced by the stacking of the elements of the respective component (281, 26, 27). The fields of two pole pieces 27 which are adjacent in the circumferential direction of the stator 2 also emerge therefrom in the circumferential direction. It is therefore necessary to select a stacking of the respective elements (264, 275, 286) which effectively prevents the emergence of the fields and the eddy currents associated therewith also in the circumferential direction. This is ideally possible in the case of the pole pieces 27 by the stacking of the pole elements 275 in the axial direction A. Likewise, as an alternative, the pole piece 27 can be produced from a soft magnetic composite (in English <<soft magnetic composite», <<SMC» for short). This ensures a similar effect. Overall, these embodiments lead to the eddy current losses being drastically reduced.

This results in the possibility, as can be seen in FIG. 2, that the pole pieces 27 can be arranged significantly closer to one another in the circumferential direction of the stator 2 and therefore several stator poles 25—here 12 in number—can be arranged in comparison with the temple motor from FIG. 1.

In preferred embodiments, the pole piece 27 is produced from a soft magnetic material. In this case, it is preferred that the pole pieces 27 and/or the segments 281 and/or the connecting leg 26 are produced from electrical sheet metal. The definition of an electrical sheet metal has already been described in previous sections. There is likewise the possibility of using Mu-metal for the production of the elements 264, 275, 286.

Further suitable soft magnetic materials for the stator poles 25 and the back iron 28 are, for example, ferromagnetic or ferrimagnetic materials, that is to say in particular iron, nickel-iron, cobalt-iron, silicon-iron or Mu-metal. In other exemplary embodiments, the pole piece 27 and/or the connecting leg 26 and/or the back iron 28 or the segments 281 can be produced from a powder composite material, in particular a soft magnetic powder composite (SMC). The definition and the advantages of this material have already been explained in previous sections.

The attachment of a pole piece 27 to a connecting leg 26 and the attachment of the connecting leg 26 to the radial part 282 of a segment 281 can be effected by the possible types of joining already explained in previous sections.

According to a specifically preferred embodiment, the stator 2 is designed such that, in addition to the contactless magnetic levitation of the rotor 3, it can also exert a torque on the rotor 3 or the magnetically active core 31 of the rotor 3 which drives the rotor 3 for rotation about a desired axis of rotation. That is to say, in this preferred design, the rotor 3 can be driven for rotation about the axial direction A.

The already mentioned widening of the end face 272 in the circumferential direction has the advantage that the magnetic functionality is thereby promoted. For example, the passive stiffness and the active levitation forces can be improved. With regard to the embodiment in which the magnetic levitation device 1 is configured for generating a torque, the advantage further results that an increased torque can be generated.

In this embodiment, the concentrated windings 61 therefore generate electromagnetic rotary fields with which the rotor 3 can be levitated both magnetically in a contactless manner with respect to the stator 2 and can also be driven in a contactless manner for rotation about the axial direction A.

The rotor 3 comprises the magnetically active core 31 which is designed in a ring-shaped or disk-shaped manner. According to the representation in FIG. 3, the magnetically active core 31 is configured as a ring and defines a magnetic central plane. Several individual magnets 311 are arranged on the magnetically active core. This is a so-called four-pole pair rotor 3. It goes without saying that rotors 3 with a number of pole pairs different from four, for example a single-pole pair rotor 3, can be used in other exemplary embodiments.

With regard to exemplary embodiments with the four-pole pair rotor 3 shown here, it is advantageous for the pole pieces 27 to be designed in a laminated manner stacked in the axial direction. If, in the operating state of the magnetic levitation device 1, a change between the individual magnets 311 of the rotor 3 just takes place at a specific pole piece 27, that is to say as detail AS marked in FIG. 2, the magnetic field enters the pole piece 27 at a first point of the pole piece 27 and exits the same pole piece 27 again at a second point which is displaced in the circumferential direction. This flux conduction is possible with low loss only in the case of pole pieces 27 which are laminated and stacked in the axial direction. Here, elements 275 which are stacked in the circumferential direction would oppose the field course during the pole change and lead to high losses.

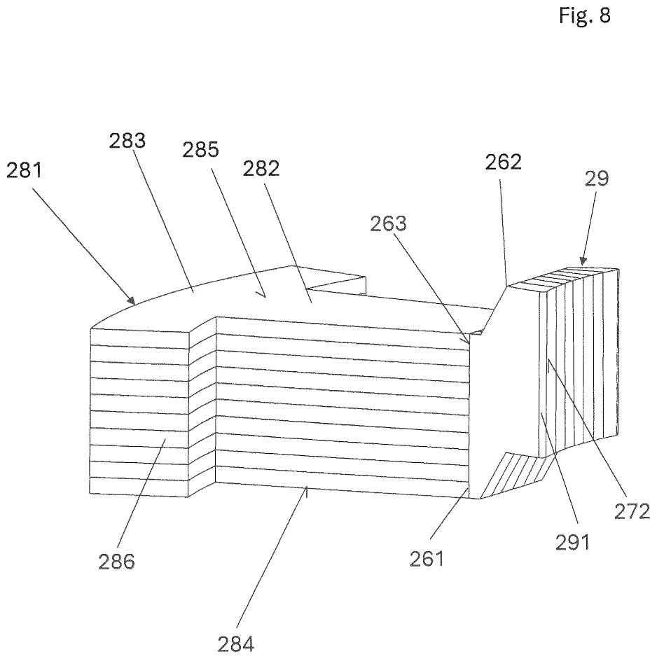

If a soft magnetic composite (SMC) is used as material for the pole piece 27 or the tooth 29 (FIG. 8), the same advantages as just described occur. Likewise, SMC is also highly suitable for use for the four-pole pair rotor 3.

Alternatively, the magnetically active core 31 can also be configured as a disk. As a rule, in the case of a disk-shaped or ring-shaped magnetically active core 31, the magnetic central plane is the geometric central plane of the magnetically active core 31 of the rotor 3 which is perpendicular to the axial direction A. In the operating state, the magnetically active core 31 is levitated in the radial plane which is perpendicular to the axial direction A.

Since it is sufficient for understanding the disclosure, only the magnetically active core 31 of the rotor 3 is illustrated in FIG. 2. It goes without saying that the rotor 3 can of course also comprise further components, such as, for example, casings or encapsulations which are preferably produced from a plastic, or from a metal or from a metal alloy or from a ceramic or a ceramic material. Furthermore, the rotor 3 can also comprise vanes for mixing, stirring or pumping fluids or other components.

When the rotor 3 is inserted into the cup-shaped recess 211 (FIG. 3), the rotor 3 and in particular the magnetically active core 31 of the rotor 3 is surrounded by the radially outwardly arranged end faces 272 of the pole piece 27 of the stator poles 25 of the stator 2.

When the magnetically active core 31 of the rotor 3 is in its desired position during operation, the magnetically active core 31 is centered between the end faces 272 of the pole pieces 27.

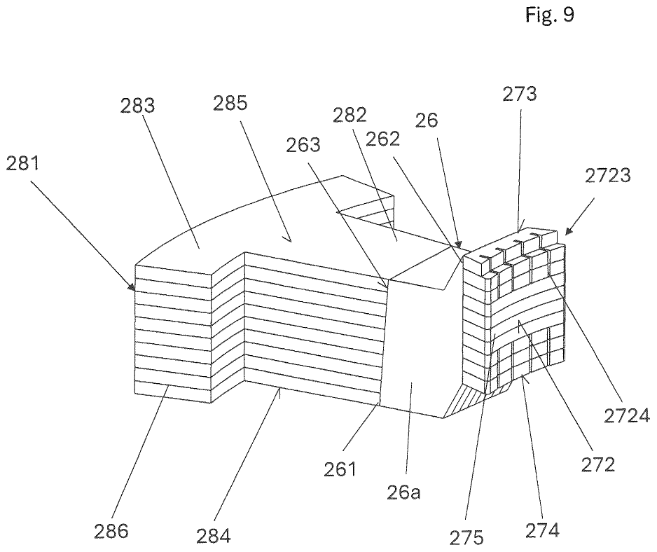

In order to generate the electromagnetic fields necessary for the magnetic levitation of the rotor 3 and optionally for generating a torque on the rotor 3, the radial parts 282 of the segments 281 carry the windings configured as concentrated windings 61. However, embodiments are also possible in which the concentrated winding 61 is arranged both on the radial part 282 and on a part of the connecting leg 26 (FIG. 9).

With these concentrated windings 61, in the operating state, those electromagnetic rotary fields are generated with which an arbitrarily adjustable transverse force can be exerted on the rotor 3 in the radial direction so that the radial position of the rotor 3, that is to say the position thereof in the radial plane perpendicular to the axial direction A, can be actively controlled or regulated. Optionally, a torque is additionally brought about on the rotor 3 with these electromagnetic rotary fields. Tilting of the rotor 3 can be passively stabilized by the ring-shaped or disk-shaped embodiment of the rotor 3. The diameter of the magnetically active core 31 of the rotor 3 is preferably at least twice as large as a core height of the magnetically active core 31, wherein the core height specifies the extent of the magnetically active core in the axial direction A.

The “magnetically active core 31” of the rotor 3 means that region of the rotor 3 which interacts magnetically with the stator 2 for the generation of the magnetic levitation forces and optionally for the torque formation.

As already mentioned, the magnetically active core 31 in this exemplary embodiment is of ring-shaped design and has several individual magnets 311 which are arranged thereon. However, exemplary embodiments in which the magnetically active core 31 has no individual magnets 311 arranged thereon are also possible. The magnetically active core 31 can then consist completely of a permanent magnetic material, with the result that the magnetically active core 31 is the permanent magnet. The magnetically active core 31 is, for example, magnetized in the radial direction.

Permanent magnets are usually referred to as those ferromagnetic or ferrimagnetic materials which are hard magnetic, that is to say have a high coercive field strength. The coercive field strength is that magnetic field strength which is required in order to demagnetize a substance. In the context of this application, a permanent magnet is understood to mean a substance or a material which has a coercive field strength, more precisely a coercive field strength of the magnetic polarization, which is more than 10′000 A/m.

Preferably, the stator 2 and the rotor 3 have a predetermined pole number combination. The pole number of the stator 2 corresponds to the number of stator poles 25, while the pole number of the rotor 3 corresponds to the number of magnetic poles, in particular the number of permanent magnets.

Preferred combinations of stator poles and magnetic poles are given in particular by the following pairs of numbers:

| stator | magnetic |
|---|---|
| poles | poles |
| 5 | 2 |
| 6 | 2 |
| 8 | 2 |
| 9 | 6 |
| 12 | 8 |
| 12 | 14 |
| 24 | 20 |
| 36 | 30 |

Such embodiments are also possible, in which the magnetically active core 31 is designed free of permanent magnets, that is to say without permanent magnets. The rotor 3 is then designed, for example, as a reluctance rotor. The magnetically active core 31 of the rotor 3 then consists, for example, of a soft magnetic material. Suitable soft magnetic materials for the magnetically active core 31 are, for example, ferromagnetic or ferrimagnetic materials, that is to say in particular iron, nickel-iron, cobalt-iron, silicon-iron, Mu-metal.

Furthermore, embodiments are possible, in which the magnetically active core 31 of the rotor 3 comprises both ferromagnetic materials and permanent magnetic materials. For example, permanent magnets can be placed or inserted into a ferromagnetic main body. Such designs are advantageous, for example, if, in the case of large rotors, it is intended to reduce the costs by saving permanent magnetic material.

Embodiments are also possible, in which the rotor is configured according to the principle of a cage rotor.

By contrast, the stator 2 is free of permanent magnets. By this designation that the stator 2 is configured “free of permanent magnets”, it is intended to be understood in the context of this application that the stator 2 does not comprise any permanent magnets which make a substantial contribution to the drive field for driving the rotation of the rotor 3 or for generating the magnetic levitation forces for the rotor 3. The magnetic flux generated by the stator 2 for the drive and the levitation of the rotor 3 therefore comprises no permanent magnetically excited flux.

It is of course possible for the rotor 3 and/or the stator 2 to comprise other magnets or permanent magnets, for example in sensors which serve, for example, to detect the angular position of the rotor, or which otherwise fulfil a purpose which has nothing to do with the generation of the magnetic flux for the drive and the levitation of the rotor 3.

The designation “free of permanent magnets” therefore relates only to the generation of the magnetic flux for the drive and the levitation of the rotor 3 by the stator 2. In other words, the stator 2 has no permanent magnets which make a contribution to the magnetic flux by which the rotor 3 is driven and levitated magnetically.

However, it is nevertheless possible for the magnetic flux for the drive and the levitation of the rotor 3 to comprise a permanent magnetic flux, but this is then generated only by the rotor 3 itself. This would be the case if the rotor 3 itself comprises a permanent magnet.

During the operation of the magnetic levitation device 1, the magnetically active core 31 of the rotor 3 interacts with the stator 2 in such a way that the rotor 3 can be levitated magnetically in a contactless manner with respect to the stator 2, and can preferably additionally be set magnetically in a contactless manner in rotation about the axial direction A. In this case, it is particularly advantageous that the same windings 61 with which the magnetic levitation of the rotor 3 is brought about also serve to generate a torque on the rotor 3. Preferably, three degrees of freedom of the rotor 3, namely its position in the radial plane and its rotation, can then be actively regulated. With respect to its axial deflection out of the radial plane in the axial direction A, the magnetically active core 31 of the rotor 3 is passively magnetically stabilized, that is to say cannot be actuated, by reluctance forces. Also with respect to the remaining two degrees of freedom, namely tilting with respect to the radial plane perpendicular to the desired axis of rotation, the magnetically active core 31 of the rotor 3 is likewise passively magnetically stabilized. The rotor 3 is therefore passively magnetically levitated or passively magnetically stabilized by the interaction of the magnetically active core 31 with the stator poles 25 in the axial direction A and against tilting (a total of three degrees of freedom) and actively magnetically levitated in the radial plane (two degrees of freedom).

As is generally customary, in the context of this application too, an active magnetic levitation denotes such a levitation which can be actively controlled or regulated, for example via the electromagnetic fields generated with the concentrated windings 61. A passive magnetic levitation or a passive magnetic stabilization denotes one that cannot be actuated or regulated. The passive magnetic levitation or stabilization is based, for example, on reluctance forces which bring the rotor 3 back into its desired position in the event of a deflection out of its desired position, that is to say, for example, in the event of a displacement or deflection in the axial direction A or in the event of a tilting.

In the magnetic levitation device 1, in contrast to conventional magnetic levitations, the magnetic levitation- and optionally the generation of a torque acting on the rotor—is realized via electromagnetic rotary fields. For the combined generation of the magnetic levitation forces and of a torque for rotating the rotor 3 about the axial direction A, it is possible, on the one hand—as shown in FIG. 2—to arrange precisely one concentrated winding 61 on each radial part 282.

On the other hand, embodiments are also possible in which two different winding systems are provided for the combined generation of the magnetic levitation forces and of a torque for rotating the rotor 3. For this purpose, precisely two concentrated windings which are arranged adjacent to one another with respect to the radial direction A are then in each case arranged, for example, on each radial part 282. One of these two windings belongs to the first of the two winding systems and the other to the second of the two winding systems.

In the embodiment illustrated in FIG. 2 with precisely one concentrated winding 61 on each radial part 282, for example, the values which are determined in each case in a control unit for the current required for the levitation and the current required for the generation of the torque are added or superimposed computationally—that is to say for example with the aid of software. The total current resulting therefrom is then impressed into the respective concentrated winding 61.

If the stator 2 of the magnetic levitation device 1 according to the disclosure is configured for generating a torque, the magnetic levitation device 1 is suitable for an electromagnetic rotary drive. It is likewise possible that the magnetic levitation device 1 according to the disclosure is also suitable for other devices such as, for example, centrifugal pumps, mixing devices for mixing flowable substances, stirring devices, for example for mixing a fluid in a tank, centrifuges, viscosity sensors, rotary filters, fans or also devices for carrying and rotating wafers, for example in semiconductor production.

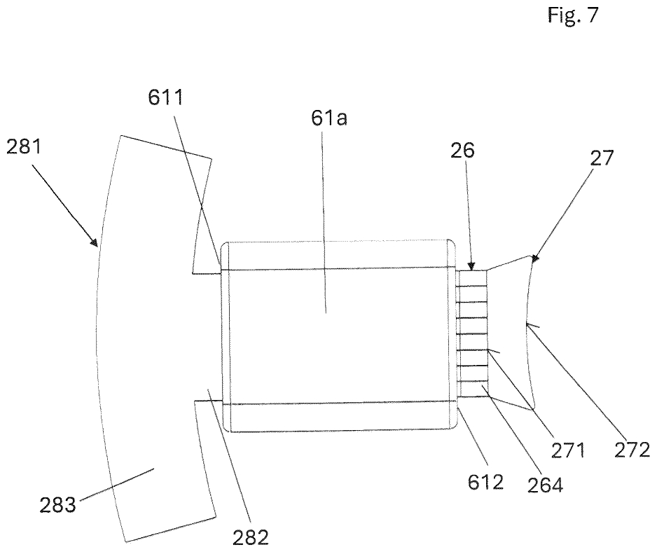

FIG. 7 shows a plan view of a segment 281 with stator pole 25 arranged thereon with a second winding form 61a. Here, the coil has a straight, rectangular form, i.e. the outer and inner diameters of the concentrated winding 61a are of equal size at the radially first end 611 and at the radially second end 612. Here, it is advantageous that this winding form is easier to produce. However, this winding form has the disadvantage that the extent of the radial part 282 in the circumferential direction is of equal size everywhere in the radial part 282 and therefore less material area is present in comparison with the radial part 282 in the first, conical winding form (FIG. 6). As a result, more iron losses occur in the second winding form than in the first winding form.

Exemplary embodiments of the magnetic levitation device 1 are also possible, in which the back iron 28 comprises both segments 281, which are surrounded by concentrated windings 61 of the first winding form from the exemplary embodiment from FIGS. 2, 5, 6, and segments 281, which are surrounded by concentrated windings 61a of the second winding form from FIG. 7.

Furthermore, exemplary embodiments of the magnetic levitation device 1 are also possible, which have the second winding form 61a from FIG. 7 and at the same time the back iron 28 comprises no segments 281, but is configured in one piece. On account of the design of the second winding form 61a, it is possible for the latter to be attached directly to a back iron 28 which has a plurality of radial parts 282. As a result of the geometric design of the second winding form 61a, the latter can simply be pushed onto the radial parts 282 without windings 61a lying next to one another mutually blocking one another. Subsequently, a pole piece 27 can be attached to each radial part 282.

FIG. 8 shows a perspective representation of a second embodiment of a segment 281 with stator pole 25 arranged thereon. In this embodiment, the connecting leg 26 and the pole piece 27 are configured in one piece as a tooth 29.

The attachment of the tooth 29 to the segment 281 can be effected by the possibilities already described above.

The tooth 29 is produced in a laminated manner from tooth elements 291, wherein the tooth elements 291 are stacked in the circumferential direction of the stator 2. Here, it is important that the stacking of the tooth elements 291 is in the circumferential direction so that the effect already described for reducing the eddy current losses at the change in orientation of the elements 286, 291 acts between the radial part 282 of the segment 281 and the tooth 29 which is arranged thereon. The selection of the materials for the tooth elements 291 can be effected analogously to the materials for the elements 264, 275, 286 of the components 281, 26, 27.

It is likewise possible to produce the tooth 29 from a solid material. In this case, the SMC already described above is suitable for the material of the tooth 29.

Further advantages of the soft magnetic powder composite material are that they have a very good capability for three-dimensional flux conduction and have a high electrical resistance and a high permeability and thus have virtually no eddy current losses. Precisely the capability for three-dimensional flux conduction, without high eddy current losses being generated in the process, ensures that soft magnetic powder composite materials are used for the tooth 29.

Since soft magnetic powder composite materials have comparatively high hysteresis losses, in some embodiments soft magnetic powder composite material is used for producing the tooth 29. As a result, a balanced means is found between the reduction of the eddy current losses at the point at which they are particularly large and the undesired influence of the powder composite material on the magnetic circuit.

FIG. 9 shows a perspective representation of a third embodiment of a segment 281 with stator pole 25 arranged thereon.

In the third embodiment, several differences from the first and second embodiment can be seen. Firstly, the extent of the radial part 282 in the radial direction is smaller than in the previous embodiments. Conversely, the extent of the connecting leg 26 in the radial direction must be increased. The respective extent of the radial part 282 and of the connecting leg 26 is to be understood by way of example in this embodiment. The first contact surface 263 can be displaced arbitrarily in the radial direction. This embodiment has the consequence that the at least one concentrated winding 61 (not shown in FIG. 9) in this exemplary embodiment is arranged both around the radial part 282 and around a part 26a of the connecting leg 26.

A further difference of this embodiment is that the end face 272 has a shape transition 2723, here designed as a step, at an edge 2721 (FIG. 4) which constitutes the transition to the pole piece surface 273. In other words, the edge 2721 which is located at the axially upper end of the end face 272 of the pole piece 27 and likewise constitutes the radially inner edge of the pole piece surface 273 has a shape transition 2723.

Since the pole piece 27 is designed in a laminated manner from pole elements 275 which are stacked in the axial direction A, the shape transition 2723 is designed such that at least one of the pole elements 275 which are located at the axially upper end of the pole piece 27 has a smaller extent in the radial direction R than the other pole elements 275. In other words, this at least one pole element 275 is set back with respect to the other pole elements 275, as viewed in the radial direction R from the rotor 3, that is to say that it is at a greater distance from the rotor 3 than the other pole elements 275.

However, a shape transition 2723 can likewise be understood to mean that the transition from the end face 272 to the pole piece surface 273 has a radius at the edge 2721. The edge 2721 can thus also be broken. A further difference in this embodiment is that the end face 272 has several slots 2724 which extend in the axial direction A.

A first number of slots 2724, more precisely four pieces, extend from the pole piece bottom surface 274 in the axial direction A and a second number of slots 2724, here likewise four, extend from the pole piece surface 273 in the axial direction A opposite the first number of slots 2724. The two numbers of slots 2724 do not touch one another in the center of the end face 272, as a result of which several pole elements 275 are not captured by the slots 2724. However, embodiments in which the slots 2724 extend over all pole elements 275 are also possible. The number of slots 2724 in this embodiment is to be understood purely by way of example; it can likewise be more or fewer.

In this embodiment, the slots 2724 are arranged parallel or approximately parallel to one another in the end face 272. The arrangement of the several slots 2724 parallel to one another is advantageous since they are thereby also arranged parallel or at least approximately parallel to the course of the magnetic field, with the result that they do not block the latter.

The introduction of slots 2724 into the end face 272 of the pole piece 27 constitutes an electrical insulation. That is to say that the slots 2724 ensure that the path of the eddy currents in the pole elements 275 is interrupted and thus blocked. Eddy currents which result from magnetic fields emerging from the pole elements 275 in the axial direction A can thus be prevented. This has the consequence that only small eddy currents remain in the pole piece 27 and the eddy current losses in the pole piece 27 as a whole are drastically reduced.

The production of the slots 2724 can be effected by various methods. These include, inter alia, mechanical methods, such as, for example, milling, punching or cutting, the latter also including the use of lasers and/or water jet cutters and/or wire erosion.

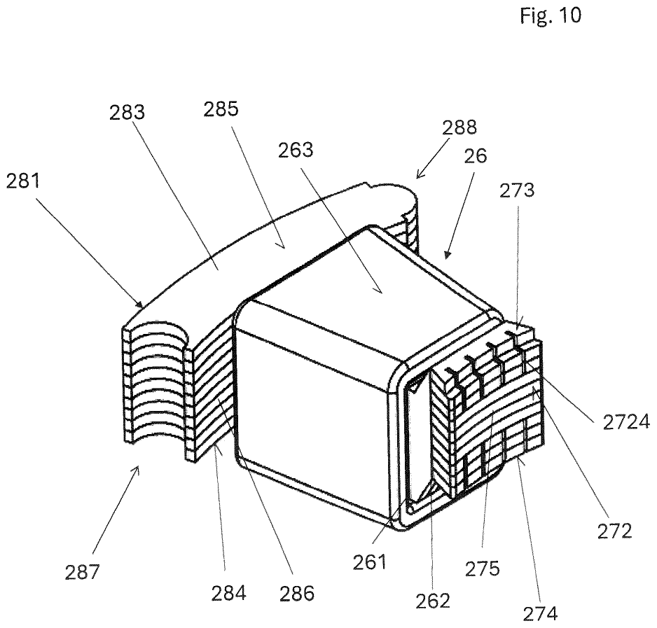

FIG. 10 shows a perspective representation of a fourth embodiment of a segment 281 with stator pole 25 arranged thereon and a first winding form.

In the following, further embodiments of a segment 281 are shown in FIG. 10 to FIG. 12. Only the differences from the previous embodiments are discussed. Identical parts, or parts that are functionally equivalent, of the further embodiments are designated by the same reference signs as in the previous embodiments. In particular, the reference signs have the same meaning as already explained in connection with the previous embodiments. It is understood that all preceding explanations of the previous embodiments apply in the same way, or in a correspondingly analogous way, also to the further embodiments. It is understood that the features shown in the embodiments can be combined with one another in any desired manner.

The segments 281 each have a first segment end 287 and a second segment end 288 in the circumferential direction. The segment 281 has a first shape, in this case a semicircular shape, at the first segment end 287 and a second shape, in this case also a semicircular shape, at the second segment end, so that the first and second shapes are complementary shapes. In other words, the first shape is a male shape at the second end 288 and the second shape is the female counterpart at the first end 287.

This means that both shapes are designed in such a way that the first segment end 287a (see FIG. 13) can be connected to a second segment end 288c of a first adjacent segment 281c in a form-fitting manner and the second segment end 288a can be connected to a first segment end 287b of a second adjacent segment 281b in a form-fitting manner. The first and second shapes are thus designed as two interlocking geometries.

This embodiment has the advantage that there is a certain degree of flexibility when joining the individual segments 281, so that they can, for example, be moved relative to each other, if necessary. This also facilitates the replacement of individual segments 281. Due to the rims of the first shape being pulled forward in this embodiment in a direction tangential to the circumferential direction, a displacement in the radial direction R between two adjacent segments 281 is reduced.

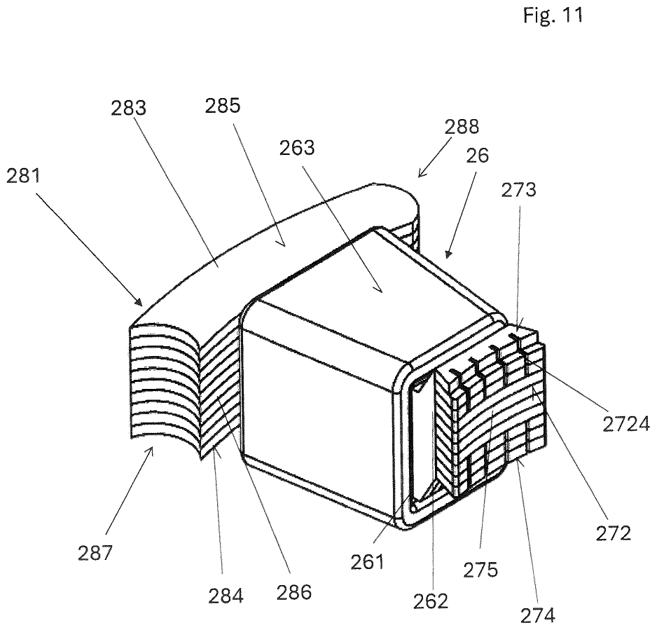

FIG. 11 shows a perspective representation of a fifth embodiment of a segment 281 with stator pole 25 arranged thereon and a first winding form.

This embodiment is very similar to the fourth embodiment, with the difference that the rims of the first shape being pulled forward are less pronounced, which makes an improved movement of the individual segments 281 between two adjacent segments 281 possible, so that a more flexible arrangement of the entire back iron 28 is possible. Especially when the magnetic levitation device 1 has to be installed in a specific housing, the increased flexibility can facilitate installation. In fact, higher manufacturing tolerances can also be possible in the manufacture of the housing and/or segment.

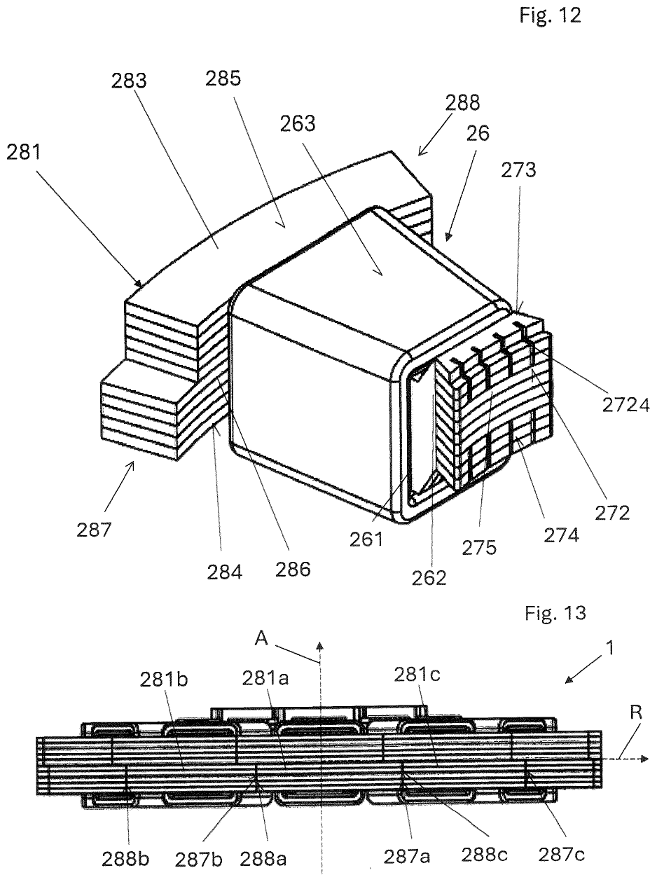

FIG. 12 shows a perspective representation of a sixth embodiment of a segment 281 with stator pole 25 arranged thereon and a first winding form.

In these embodiments, the first and second shapes have a stepped shape in the axial direction A, wherein the steps at the first and second segment ends 287, 288 are designed to be complementary to each other so that this segment 281 can be joined to adjacent segments 281.

In the following, further exemplary embodiments of a magnetic levitation device 1 according to the disclosure are shown in FIGS. 13 to 15. Only the differences from the first exemplary embodiment are discussed. Identical parts, or parts that are functionally equivalent, of the further exemplary embodiments are designated by the same reference signs as in the first exemplary embodiment. In particular, the reference signs have the same meaning as already explained in connection with the first exemplary embodiment. It is understood that all preceding explanations of the first exemplary embodiment apply in the same way, or in a correspondingly analogous way, also to the further exemplary embodiments. It is understood that the features shown in the exemplary embodiments can be combined with one another in any desired manner.

FIG. 13 shows a schematic sectional representation of a second exemplary embodiment of a magnetic levitation device 1 according to the disclosure. In this exemplary embodiment, the segments 281 are designed according to the sixth embodiment shown in FIG. 12. Three segments 281a, b, c are shown here as examples of how they are connected to each other at the segment ends.

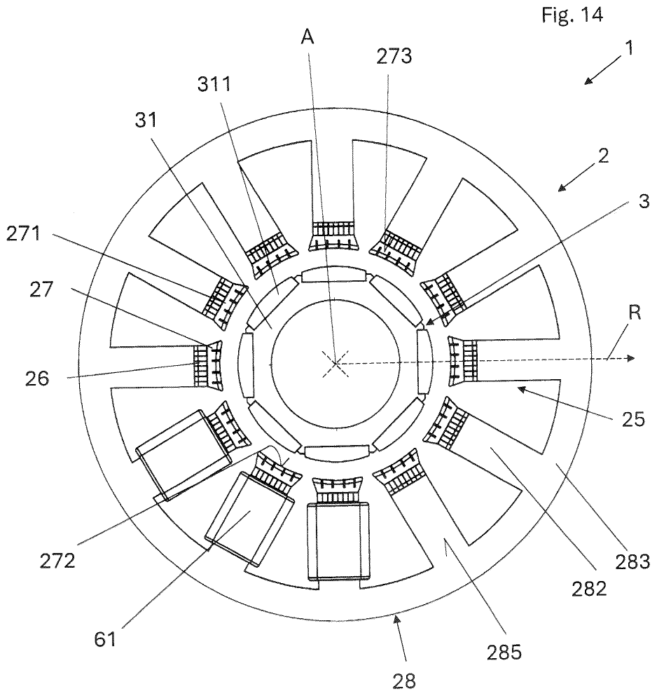

FIG. 14 shows a plan view on a third exemplary embodiment of a magnetic levitation device 1 according to the disclosure. In this exemplary embodiment, the back iron 28 is designed in one piece and has a circumferential part 283. For better visibility and representability, only three of the stator poles 25 are shown with a winding 61 in this embodiment. It is understood that, for normal proper operation of the magnetic levitation device 1, at least one winding 61 is attached to all stator poles 25.

The manufacture of such a magnetic levitation device 1 is advantageous because few individual components are required in this case. First, a back iron 28 with a circumferential part 283 and the desired number of radial parts 282 is manufactured. This component can be imagined as a wheel with spokes that do not extend to the center (“hub”) of the wheel. Subsequently, a winding 61 is placed on each radial part 282. Subsequently, the connecting leg 26 and then the pole piece 27 are attached using the aforementioned manufacturing methods. Depending on the manufacturing method, it is also possible that the connecting leg 26 and pole piece 27 are already connected and/or designed in one piece and are then attached to the radial part 282 as a common part.

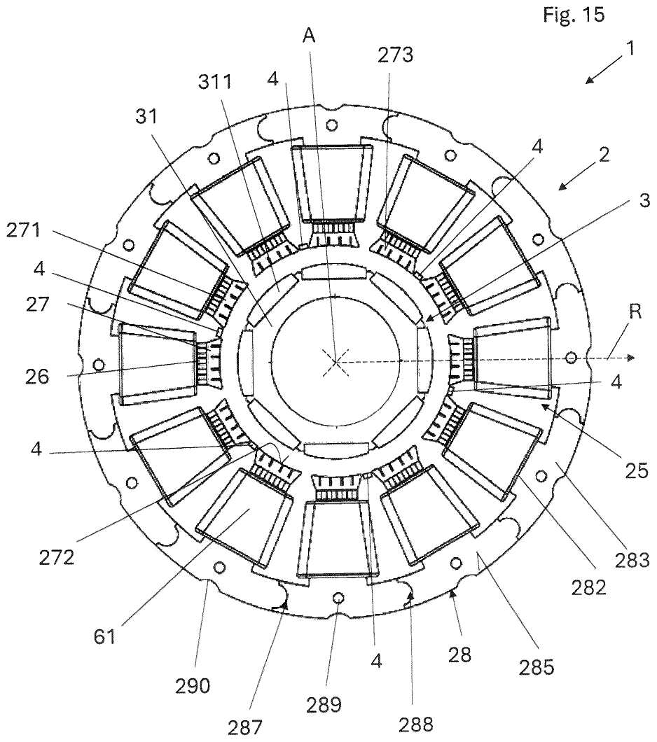

FIG. 15 shows a plan view on a fourth exemplary embodiment of a magnetic levitation device 1 according to the disclosure. In this exemplary embodiment, the segments 281 are designed according to the fourth embodiment shown in FIG. 10. Furthermore, each segment 281 has a bore 289 in the axial direction A through the segment 281 and a curvature 290.

The bore 289 can serve to fix the magnetic levitation device 1 or the segments to a foundation, e.g., a housing, using fixing means such as screws or rivets. The position of the bores 289 is to be understood as an example and can also be arranged at other positions of the segments 281. The curvatures 290 are advantageous, for example, when the magnetic levitation device 1 is installed in a very narrow (precisely fitting) housing. They can then be used, for example, as feed-throughs for cables or for better distribution of the casting compound so that it can flow around the entire stator 2.

In other exemplary embodiments, which have segments with a first and second shape that are designed to be rounded or semi-rounded, as shown in FIGS. 10-12, for example, a ring can be attached around the back iron 28 on its radially outer side to provide stability or fixation. This serves as a clamping ring or tension ring and can be a steel band, for example.

In this exemplary embodiment, the magnetic levitation device 1 further comprises a plurality of sensors 4, e.g., for determining the rotor position and/or the angle of rotation of the rotor. In this case, a sensor 4 is arranged between every second stator pole 25. The arrangement of the sensors 4 in this exemplary embodiment is to be understood as purely exemplary. The sensors 4 can also be arranged at other positions of the magnetic levitation device 1. In addition, the number of sensors 4 is also to be understood as exemplary, more or fewer sensors 4 can be present in the magnetic levitation device 1.

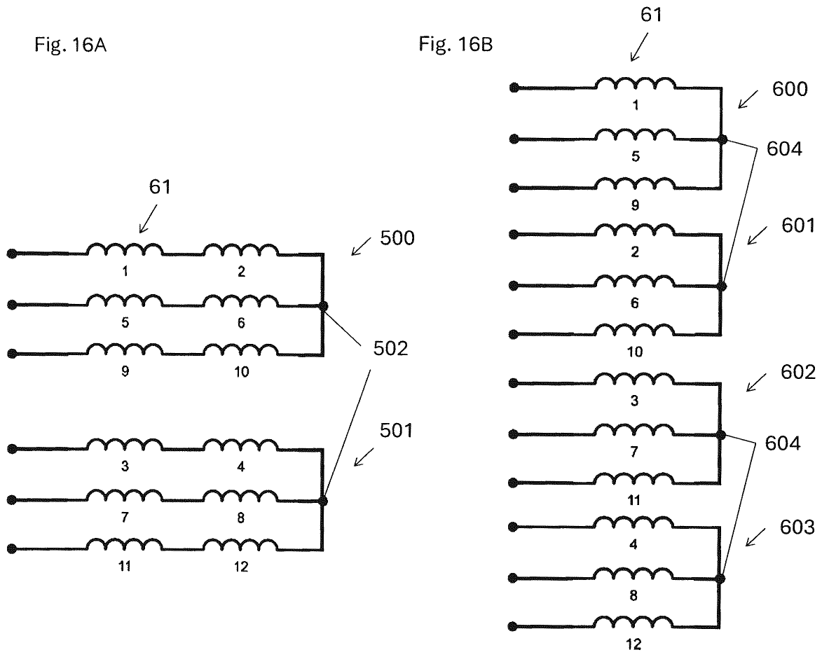

FIGS. 16A and 16B show a schematic representation of the wiring of a magnetic levitation device according to the disclosure for controlling and regulating it. In FIG. 16A, a 6-phase winding arrangement is shown, and in FIG. 16B, a 12-phase winding arrangement.

The winding arrangement in FIG. 16A comprises a first three-phase winding set 500 and a second three-phase winding set 501, wherein the two winding sets 500, 501 are designed to be electrically separated from each other and together form a six-phase wiring system. Each winding set comprises six windings 61.

Each winding set 500, 501 is preferably designed as a star connection and has a respective star point 502 at which the associated windings 61 are connected to each other.

Furthermore, each winding set 500, 501 comprises in each case two windings 61 connected in series, which form one phase, so that there is one series winding per phase. The windings 61 are connected in a preferred orientation to ensure a defined magnetic polarity and a symmetrical field distribution within the system.

In preferred exemplary embodiments, the two windings connected in series are wired with opposite polarity, i.e., they have opposite winding directions.

The winding arrangement in FIG. 16B comprises four separate three-phase winding sets 600, 601, 602, 603, which together form a twelve-phase system.

Each of the four winding sets 600, 601, 602, 603 is preferably designed as a star connection and has in each case its own star point 604, at which the three associated windings 61 are electrically connected to one another. The star points 604 of the individual winding sets 600, 601, 602, 603 are particularly preferably electrically isolated from one another, so that a total of four separate star points 604 are formed.

Each winding set 600, 601, 602, 603 comprises three windings 61, wherein in each case one single winding 61 is provided per phase.

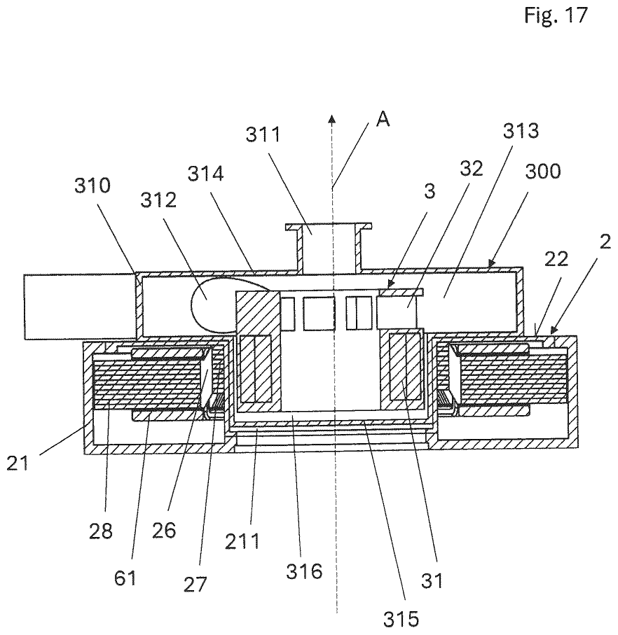

FIG. 17 shows a sectional representation of a magnetic levitation device according to the disclosure with a pump unit inserted therein.

In FIG. 17, a pump unit 300 is inserted into the magnetic levitation device 1 according to the disclosure, the pump unit 300 comprising the rotor 3. The pump unit 300 comprises a pump housing 310 with an inlet 311 and with an outlet 312 for a fluid to be conveyed. The rotor 3 is arranged in the pump housing 310 and has a plurality of vanes 32 for conveying the fluid. The pump housing 310 delimits a pump chamber 313. Furthermore, the pump housing 310 has a cover part 314 and a base part 315, wherein the base part 315 has a cylindrical cup 316 for receiving the rotor 3. The cup 316 is thus inserted into the cup-shaped recess 211 of the stator 2.

On the basis of the representation in this figure, it can be clearly seen why the offset between the back iron 28 and the pole piece surface 273 is advantageous.

The pump unit 300 can be inserted in a precisely fitting manner into the cup-shaped recess 211, such that a flat surface 22 of the stator housing 21 is achieved. Furthermore, as a result of the offset V between the pole piece 27 and the back iron 28, the rotor 3 can be lifted to the maximum extent upward in the axial direction A with respect to the axially upper surface 22 of the stator housing 21, that is to say further away from the second end AE2 of the stator 2 in the axial direction A. As a result of this maximum lifting of the rotor 3 in the axial direction A, the rotor 3 can be designed more compactly, as a result of which the stability of the levitation of the rotor 3 in the stator 2 is improved.

Precisely if the pump unit 300 or the rotors 3 are used for use as a mixer of a fluid, the vanes 32 can have a smaller extent in the axial direction A, as a result of which forces acting on the vane 32 further upward in the axial direction A are prevented. As a result, tilting moments are reduced and the levitation of the rotor 3 is ensured well and reliably.

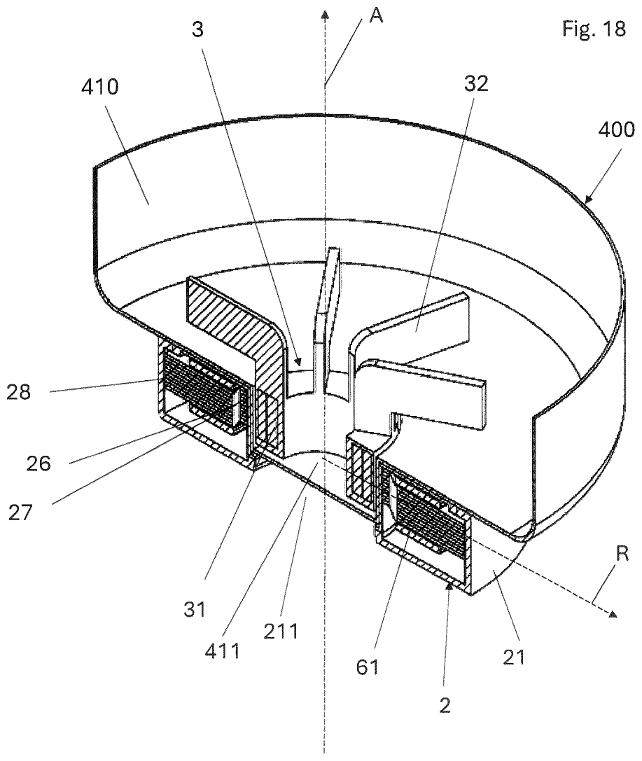

FIG. 18 shows a perspective sectional representation of a magnetic levitation device according to the disclosure with a mixing unit inserted therein.

In FIG. 18, a mixing unit 400 is inserted into the magnetic levitation device 1 according to the disclosure, wherein the mixing unit 400 comprises the rotor 3. The mixing unit 400 comprises a mixing container 410 (shown here only partially) which usually has an inlet and an outlet (not shown here; the inlet and outlet are often combined) for a substance to be mixed in, e.g., a fluid. The rotor 3 is arranged in the mixing container 410 and has a plurality of vanes 32 for mixing the substance. At the axially lower end of the mixing container 410, the latter has a cylindrical cup 411 for receiving the rotor 3. The cup 411 is thus inserted into the cup-shaped recess 211 of the stator 2.

On the basis of the representation in this figure, it can be clearly seen why the offset between the back iron 28 and the pole piece surface 273 is advantageous.

The mixing unit 400 can be inserted in a precisely fitting manner into the cup-shaped recess 211, such that a flat surface 22 of the stator housing 21 is achieved. Furthermore, as a result of the offset V between the pole piece 27 and the back iron 28, the rotor 3 can be lifted to the maximum extent upward in the axial direction A with respect to the axially upper surface 22 of the stator housing 21, that is to say further away from the second end AE2 of the stator 2 in the axial direction A. As a result of this maximum lifting of the rotor 3 in the axial direction A, the rotor 3 can be designed more compactly, as a result of which the stability of the levitation of the rotor 3 in the stator 2 is improved.

Precisely if the mixing unit 400 or the rotors 3 are used for use as a mixer of a fluid, the vanes 32 can have a smaller extent in the axial direction A, as a result of which forces acting on the vane 32 further upward in the axial direction A are prevented. As a result, tilting moments are reduced and the levitation of the rotor 3 is ensured well and reliably. It goes without saying that all the exemplary embodiments and embodiments shown in the description of the figures can be combined with one another in any form with their respective characteristics and components.

What is claimed:

1. A magnetic levitation device for the contactless magnetic levitation of a rotor which has a disk-shaped or ring-shaped magnetically active core, the magnetic levitation device comprising:
a stator extending in an axial direction and having a cup-shaped recess which is arranged at a first axial end of the stator and into which the rotor is configured to be inserted, the stator having a back iron, the back iron having a plurality of radial parts, at least one circumferential part, a back iron bottom surface and a back iron surface, each radial part of the plurality of radial parts extending from the at least one circumferential part in a radial direction which is perpendicular to the axial direction, the back iron surface facing a first axial end of the stator and the back iron bottom surface facing a second axial end of the stator, the stator having a plurality of stator poles, each stator pole of the plurality of stator poles having a connecting leg and a pole piece,
for each stator pole of the plurality of stator poles, the connecting leg extending from a first end to a second end, the first end abutting the back iron, the pole piece having a contact surface abutting the second end of the connecting leg, the pole piece extending from the contact surface in the radial direction to an end face, and the end face arranged around the cup-shaped recess, and
at least one concentrated winding arranged on each radial part of the plurality of radial parts, and surrounding a respective radial part,
for each stator pole of the plurality of stator poles, each connecting leg extending from the first end obliquely with respect to the axial direction radially inwards to the second end, such that the back iron surface and a pole piece surface of the pole piece are arranged with an offset with respect to the axial direction.

2. The magnetic levitation device according to claim 1, wherein the back iron comprises several segments), each segment of the several segments having a radial part of the plurality of radial parts and a circumferential part of the plurality of circumferential parts.

3. The magnetic levitation device according to claim 1, wherein the stator has twelve stator poles, and the rotor has a plurality of rotor poles, preferably eight rotor poles, wherein the rotor poles are configured as four pole pairs.

4. The magnetic levitation device according to claim 1, wherein the at least one concentrated winding has a conical configuration.

5. The magnetic levitation device according to claim 1, wherein the at least one concentrated winding has a radial first end and a radial second end, the radial first end facing the circumferential part and the radial second end facing the cup-shaped recess, the at least one concentrated winding having a first outer diameter at the radial first end and a second outer diameter at the radial second end, the first outer diameter being greater than the second outer diameter.

6. The magnetic levitation device according to claim 1, wherein for each stator pole of the plurality of stator poles, the end face of the pole piece is a curved surface.

7. The magnetic levitation device according to claim 1, wherein for each stator pole of the plurality of stator poles, the end face is wider with respect to the circumferential direction than a maximum extent of the contact surface in the circumferential direction.

8. The magnetic levitation device according to claim 1, wherein for each stator pole of the plurality of stator poles, the end face has a shape transition at an edge which constitutes a transition to the pole piece surface.

9. The magnetic levitation device according to claim 1, wherein the back iron is produced in a laminated manner from back iron elements, the back iron elements being stacked in the axial direction.

10. The magnetic levitation device according to claim 1, wherein for each stator pole of the plurality of stator poles, the connecting leg is produced in a laminated manner from elements, the elements being stacked in the circumferential direction of the stator.

11. The magnetic levitation device according to claim 1, wherein for each stator pole of the plurality of stator poles, the pole piece is produced in a laminated manner from pole elements, the pole elements being stacked in the axial direction.

12. The magnetic levitation device according to claim 1, wherein for each stator pole of the plurality of stator poles the connecting leg and the pole piece are configured in one piece as a tooth, the tooth is produced in a laminated manner from tooth elements, the tooth elements being stacked in the circumferential direction of the stator or the tooth is produced from a soft magnetic material.

13. The magnetic levitation device according to claim 1, wherein the stator is configured to generate a torque with which the rotor is capable of being driven magnetically in a contactless manner to rotate about the axial direction.

14. The magnetic levitation device according to claim 13, wherein the magnetic levitation device is an electromagnetic rotary drive, mixing device, centrifuge, cross-flow fan, rotary filter or viscometer.

15. A pump unit for a magnetic levitation device claim 1, the pump unit comprising:
the rotor;
a pump housing with an inlet and an outlet to convey a fluid, the rotor being arranged in the pump housing, the rotor having a plurality of vanes to convey the fluid, the pump housing delimiting a pump chamber and having a cover part and a base part, the base part having a cylindrical or conical cup to receive the rotor, cup configured to be inserted into the cup-shaped recess of the stator.

16. The magnetic levitation device according to claim 1, wherein for each stator pole of the plurality of stator poles, the end face of the pole piece is a curved surface and a rounding of the end face is coaxially with respect to the cup-shaped recess.

17. The magnetic levitation device according to claim 1, wherein for each stator pole of the plurality of stator poles, the end face has a rounding off or a step at an edge which constitutes a transition to the pole piece surface.
